(19) United States
(12) Patent Application Publication
(10) Pub. No.: US 2015/0286748 A1
(43) Pub. Date: Oct. 8, 2015

(54) Data Transformation System and Method

(71) Applicant: RedPoint Global Inc., Wellesley Hills, MA (US)

(72) Inventor: John Lilley, Boulder, CO (US)

(21) Appl. No.: 14/680,973

(22) Filed: Apr. 7, 2015

Related U.S. Application Data
(60) Provisional application No. 62/104,042, filed on Jan. 15, 2015.
(60) Provisional application No. 61/977,078, filed on Apr. 8, 2014.

(51) Int. Cl. G06F 17/30

(52) U.S. Cl. CPC G06F 17/30958; G06F 17/30734; G06F 17/30563; G06F 17/30595

(57) ABSTRACT

A computer-implemented system and method for performing data-processing in a computing environment having a file system (FS) and a computing system (CS) to process at least one original Directed Graph (DG) having multiple edges and vertices. The DG includes at least one input vertex representing a source of data elements from the FS with each input vertex having at least one attribute that specifies data element processing constraints, at least one output vertex representing a destination of data elements, and at least one transform vertex representing transformation operations on the data elements. The system and method analyze and condition data elements available from the DG input vertices, and customize the original DG into at least one customized DG. A list of Tasks is created for execution in the CS to process the customized DG in an execution engine capable of performing requested data transformations in the computing environment.

### CROSS-REFERENCE TO RELATED APPLICATION

This application claims priority to U.S. Provisional Application No. 61/977,078 filed 8 Apr. 2014 and to U.S. Provisional Application No. 62/104,042 filed 15 Jan. 2015.

### FIELD OF THE INVENTION

This invention relates to data transformation systems including distributed processing systems that execute data transformations based on a Directed Graph (DG) specification.

### BACKGROUND OF THE INVENTION

Distributed processing systems that execute data transformations based on a Directed Graph (DG) specification have existed in various commercial forms for some time prior to the present invention and are used to carry out, among other tasks, database-oriented processing variously known as “Extraction, Transformation, and Loading” (ETL) systems or “Extraction, Loading, and Transformation” (ELT) systems.

At the heart of these systems is a user-specified directed graph (DG) representing the flow of data elements (a.k.a. “records”) from Inputs, through Transforms and to Outputs. Most such systems are limited to Directed Acyclic Graphs (DAGs), but the scope of the present invention applies to all types of DG, singular and plural, including one or more DAGs. The vertices in a directed graph represent the Inputs, Transforms and Outputs, and the edges in the graph represent connections or pipelines along which data elements flow from one vertex to another. Input vertices have one or more outgoing edges and no incoming edges. Output vertices have one or more incoming edges and no outgoing edges. Transform vertices have a combination of incoming and outgoing edges.

A vertex may have one or more port types, and each port may accept zero or more edges to other vertices in the DG. Port types define different semantics for data flowing into or out of each transform. Port types are further distinguished by being “inputs” or “outputs”, indicating whether the port produces data elements into an edge, or consumes data elements from a edge. A port type may be “unnamed” if doing so does not cause ambiguity. For example, a vertex intended to perform a table lookup and replacement operation may have two input port types: one port type for the table and the other port type for the data to be transformed, and one unnamed output port type.

An edge connects an output port on one vertex to an input port on a second vertex, and represents a “pipeline” through which data elements produced by the first vertex flow until consumed by the second vertex. The size of the “pipeline” may be bounded or unbounded.

Such DG systems typically include practical features including but not limited to the following:
A user interface for selecting vertices from a palette of available vertices, configuring the parameters of such vertices, and interconnecting them into a DG.
Input vertices for reading many file formats and querying data from relational database management systems (RDBMS).
Output vertices for writing many file formats and inserting or updating records into RDBMS.
Transform vertices for expression-based data calculations.
Transform vertices for sorting, joining, summarizing, grouping, and uniqueness.
Input and output vertices for indexing, searching, and retrieval.
Transform vertices that implement rules for detection and correction of erroneous data values.
Transform vertices for parsing and standardization of people, businesses, addresses, products, and other entities.
Transform vertices for fuzzy-matching and linkage of entities based on similarity rules.
Transform vertices for integration and deduplication of multiple instances of entities.
Transform vertices for machine-learning, modeling, statistical analysis, and prediction.
Transform vertices for geocoding, geo-spatial analysis, polygon processing, mapping.

For purposes of the present invention, the term “DG” or “Directed Graph” includes a collection of non-interconnected DGs, also referred to as a “forest” of DGs, as well as a single DG. Exemplar known DGs 1100A-1100E, and components thereof, are shown in FIGS. 1A-1E, wherein the following items are identified:
Input vertices 1100A-H.
Output vertices 1103A-J.
A transform vertex 1101A with unnamed input and output Port types.
A transform vertex 1101B with two input Port types L and R, and three output Port types L, J, and R. Such a vertex with output Port “J” could be used to represent a “join” operation.
A transform vertex 1102C with unnamed input and output Port types, the output port of which is connected to several other vertices 1103B-D. Depending on the vertex semantics, such a topology may be used to represent replication or distribution of data elements amongst all downstream vertices 1103B-D.
A set of vertices 1101C-F representing a sub-DG, FIG. 1B, which consists only of an input and output vertex.
A set of vertices 1101D, 1102D, 1103G, 1103H representing another sub-DG, FIG. 1C.
A transform vertex 1102D, FIG. 1C, with a single unnamed input Port type and two output Port types Y and N. Such a vertex could be used to represent a “filter” operation in which a single stream of input data elements is separated into those that meet a user-specified criteria and those that do not.
A transform vertex 1102E, FIG. 1D, with unnamed input and output Port types, the input port of which is connected to several other vertices 1101E, 1101F, 1101G. Depending on the vertex semantics, such a topology may be used to represent merging of data elements from all upstream vertices 1101E, 1101F, 1101G.
Yet another sub-DG, FIG. 1E, consisting of 1101H, 1102F, and 1103J which contains a cycle.

A Distributed File System (DFS) is a system comprising a collection of hardware and software computer components designed to facilitate high-performance, fault-tolerant data storage, typically arranged as a collection of nodes inter-connected via a data network, each node comprising software and storage components. A Distributed Computation System (DCS) is a system comprising a collection of hardware and software computer components, typically arranged as a collection of nodes inter-connected via a data network, each node comprising software, CPU, memory and storage components. Use of a plurality of nodes for the DFS and/or the DCS is commonly referred to as “cluster computing” or sometimes as “grid computing” or “cloud computing”; all of these configurations are encompassed by the term “parallel computing environment” as utilized herein.

As of January 2015, examples of parallel computing environments include:
Hadoop: http://en.wikipedia.org/wiki/Apache_Hadoop, http://hadoop.apache.org/
Distributed Computing Environment (DCE):
http://en.wikipedia.org/wiki/Distributed_Computing_Environment
Google Cloud Platform: https://cloud.google.com/
Microsoft Azure: http://azure.microsoft.com/en-us/
Amazon Elastic Map Reduce (EMR) based on Hadoop:
http://aws.amazon.com/elasticmapreduce/

### Examples of DCS Include:

Hadoop Yet Another Resource Negotiator (YARN):
http://hadoop.apache.org/docs/current/hadoop-yarn/hadoop-yarn-site/YARN.html
Message Passing Interface (MPI):
http://en.wikipedia.org/wiki/Message_Passing_Interface
Microsoft High Performance Computing (HPC):
http://www.microsoft.com/hpc/en/us/product/cluster-computing.aspx
IBM Platform HPC (based on MPI): http://www-03.ibm.com/systems/platformcomputing/products/hpc/index.html

### Examples of DFS Include:

Hadoop Distributed File System (HDFS):
http://en.wikipedia.org/wiki/Apache_Hadoop#HDFS, http://hortonworks.com/hadoop/hdfs/
Microsoft DFS:
http://en.wikipedia.org/wiki/Distributed_File_System %28 Microsoft %29
Google File System (GFS): http://en.wikipedia.org/wiki/Google_File_System
Amazon S3: http://en.wikipedia.org/wiki/Amazon_S3

Certain known examples of clusters 1200A-1200F are illustrated in FIGS. 2A-2F. Cluster 1200A, FIG. 2A, for example, includes a DFS Master 1210, a DCS Master 1230 and a Client 1240 sharing a network interconnect NI with a plurality of worker nodes 1220A, 1220B, etc. A DCS facilitates the speedup of computational tasks by allowing such tasks to be decomposed into cooperating and inter-communicating sub-tasks. A DCS is potentially coordinated by one or more DCS master 1230 nodes.

As described below beginning with FIG. 6A, the present invention can utilize one or more of a DFS and/or a DCS as a file system (FS) and a computing system (CS), respectively. A file system (FS) is intended by the present inventor to include any software and/or hardware mechanism for storing data elements to persistent media such as rotating magnetic media or solid-state media, and may include software systems that provide access to such storage via a programmatic interface such as relational database management systems (RDBMS), storage area networks (SAN) or distributed file systems (DFS). In one construction according to the present invention, the nodes of the DFS and DCS are co-located in a unitary computing environment, as the description herein indicates, although the invention is not limited to systems where the DCS and DFS are co-located. As utilized herein, the combination of all hardware and software components of the DFS and DCS may be referred to as a Cluster, such as cluster 1200A, FIG. 2A.

A DFS is potentially coordinated by one or more DFS Masters 1210. The DFS is supported by one or more (usually many) DFS Nodes 1250, shown in more detail in FIG. 2E. Files in the DFS are divided into blocks. Blocks may be of varying size but are usually large so as to facilitate lower network overhead, smaller directory size, and fewer disk operations. Blocks are typically replicated with the replicas being stored on separate DFS Nodes so as to support resiliency in the face of hardware failure. Within each DFS Node, blocks of data are stored in the DFS Block Storage 1251, which is comprised of one of more persistent data-storage devices such as rotating magnetic disk media or solid state storage. The DFS Master 1210, FIG. 2B, may contain these software components, provided here for illustrative purposes only:
A Directory Manager 1211 which tracks the mapping of logical file names and directory hierarchies onto lists of storage blocks.
A storage map 1212 which tracks the location of storage block replicas in DFS Nodes (1250).
A block replicator 1213 which monitors and ensures block storage redundancy so as to support resiliency of the DFS in the face of hardware failure.
An integrity checker 1214 which monitors the logical consistency of files and storage blocks so as to prevent access to corrupt files.
A balancer 1215 which ensures level distribution of storage blocks amongst the DFS Nodes.
A DFS client-master interface 1216 which communicates with Clients 1240 and Client Tasks 1266A-C via a network protocol to provide all of the typical support found in a standard file system for opening, closing, listing, removing, and so on, as well as support for querying the physical location of file block replicas.
A DFS Node interface 1217 which communicates with DFS Nodes 1250 to coordinate block-level file access by Clients 1240 and Client Tasks 1266A-C.

Each DFS Node 1250, FIG. 2E, may contain these software and hardware components, provided here for illustrative purposes only:
A DFS Block Storage 1251 which is comprised of one of more persistent data-storage devices such as rotating magnetic disk media or solid state storage.
A DFS Block Directory 1252 which is a software service that tracks the collection of blocks stored on the node.
A DFS Node-Client interface 1253, which communicates with Clients 1240 and Client Tasks 1266A-C via a network protocol to provide support for reading and writing individual file blocks that are stored on the node.
A DFS Master interface 1254, which communicates with the DFS Master 1210 in order to coordinate the allocation, reading, and writing of file blocks for logical files in the file system.

A DCS is potentially coordinated by one or more DCS Masters 1230. The DCS processes requests from Clients 1240 for units of computation resource (a “Task Container”) defined by CPU, memory, or other parameters. Multiple clients may request multiple Task Containers simultaneously, and the clients may furthermore request that tasks be run on specific nodes (“affinity”). The DCS coordinates all such requests, allocating Task Containers to Clients so as to balance computational load, satisfy affinity, and follow a scheduling strategy. When Task Containers are allocated to Clients, the Clients communicate with the DCS Nodes 1260 so as to launch Client Tasks 1266A-C which collectively carry out the computation needed by the Client. The DCS Master 1230, FIG. 2C, may contain these software components, provided here for illustrative purposes only:
A Resource Manager 1231 which tracks the resources assigned to the Task Containers of each DCS Node 1260 so as to avoid resource overuse.
A Task Scheduler 1232 which follows a defined algorithm to achieve goals of throughput, responsiveness, or fairness. It manages the outstanding set of requests from Clients and allocates Task Containers.
A DCS Master-client interface 1233 which communicates with Clients 1240 via a network protocol, receiving Task Container requests and replying with Task Container allocations.
A DCS Node interface 1234 which communicates with DCS Nodes 1260, coordinating the launching of Client Tasks 1266A-C in allocated containers.

Each DCS Node 1260, FIG. 2F, hosts Task Containers and the Client Tasks 1266A-C that run within such containers. Each DCS Node may contain these software and hardware components, provided here for illustrative purposes only:
CPU 1261 which is physical hardware for performing computations.
Memory 1262 which is physical hardware for fast, randomly-accessed, non-persistent data storage.
Working storage 1263 which is comprised of one of more data-storage devices such as rotating magnetic disk media or solid state storage.
A DCS Master interface 1264, which communicates with the DCS Master 1230 via a network protocol, coordinating Task Containers that have been allocated by the DCS Master 1230 on behalf of a Client 1240 on the node.
A Task Manager 1265, which launches and monitors Client Tasks 1266A-C.
Client Tasks 1266A-C, which are the tasks run on behalf of Clients 1240.

Clients 1240 may be connected to the Cluster via a data network so as to be able to communicate with any component of the Cluster. Clients 1240 may establish communication with the DFS Master 1210 and request access to read and write data into the DFS, as well as querying the physical location of file blocks so as to assist in the optimal scheduling of tasks to read and write data blocks on the same node on which the data blocks are stored, using the affinity mechanism of the DCS scheduler.

A logical file stored in the DFS 1300, FIG. 3, of a Cluster is thus divided into four blocks 1301 in one example. Each block 1-4 is replicated one or more times according to the DFS replication factor, and block replicas are mapped for storage, as represented by storage map interconnections 1302, onto worker nodes 1303 in the Cluster such that no two replicas of the same block are stored on the same worker node 1303. Each of Worker Nodes1-5 is a DFS node.

In view of the above-described known possibilities, a Cluster can be said to have the following quality: given applications that are required to read and write large amounts of data, it is possible to divide the application into multiple Tasks, and schedule these Tasks on the Cluster such that each Task is likely to perform its computation on the same node that owns one or more Blocks of the data files that are to be processed by the application, thus improving the aggregate performance of the Cluster by reducing the load of transporting file data over the network interconnect. It is also possible to sort large amounts of data in a distributed fashion. Furthermore, a Cluster supports applications that scale, that is, that increase aggregate performance with additional computation power. Such scalability is central to “big data” applications where, in certain constructions, terabytes or petabytes of data are processed at once.

Also known are methods for dividing data processing between multiple nodes of a Cluster, and thus achieving scalability of computation for a Cluster. The present invention is compatible with those methods that are most applicable to the class of problems encountered in data-intensive DG processing on a DFS+DCS system, namely those methods that achieve scalable computation on large data sets that are stored in a DFS and which may be limited by available I/O (Input/Output) bandwidth.

Given a file stored in a DFS or, by extension, databases that utilize DFS storage or other FS (file system) storage, a software application may analyze the files using format-specific logic to determine appropriate split positions in the file, such that dividing the file at a given split position will not divide any atomic data elements contained in the file. For example, a delimited text file may be split at end-of-line boundaries, and a fixed-length record file may be split at any even multiple of the record length. One example of a known Mapping System 1400, with mapping of file blocks and positional splits to tasks with worker affinity, is illustrated in FIG. 4 with Logical file 1401 containing four Blocks 1-4 in this example. A list of split positions for a file may be converted to a list of Positional splits 1402, where each Positional split 1402 contains:
Path: the location of the file in the FS;
Offset: the position in the file where the Positional split's first data element is stored, which may be expressed in bytes or other means appropriate to the FS; and
Length: the length of data in the file assigned to the Positional split, which may be expressed in bytes, data element count, or other means appropriate to the FS.

For many file formats, it is possible to divide the file into a list of non-overlapping Positional data splits 1402, such that reading the list of Positional splits 1402, whether sequentially or in parallel, will in aggregate read the same set of bytes as if a single process were to read the entire file at once. These Positional splits 1402 are said to “cover” the file. In this example, Positional Split 1 covers Block 1, Positional Split 2 covers Block 2 and a portion of Block 3, and Positional Split 3 covers the remainder of Block 3 and all of Block 4. If the Positional splits 1402 are chosen so as to not divide atomic data elements of the file (usually “records”), it is also possible to read such a list of Positional splits 1402, either sequentially or in parallel, such that the same set of data elements (e.g. records) are read as if a single process were to read the entire file at once. This logic may be extended to include a collection of files as well as a single file.

Given a large file 1301, 1401 or collection of files stored in a DFS (or by extension, large databases that utilize DFS storage), a software application may query the DFS to determine the physical locations of the data blocks 1301, 1401, which can be represented as a mapping 1302 from a {Path, Offset, Length} tuple describing a file block to a list of names of nodes 1303, 1406 that physically store the file blocks. The term “tuple” is utilized herein with its ordinary computer science meaning of an ordered list of elements.

Given the block-to-nodes mapping 1302, FIG. 3, the software may then find a list of Positional splits 1402, FIG. 4, that cover the input file(s), and for many file formats it is possible to find a list of Positional splits 1402 that are very close the boundaries of the file blocks reported by the DFS. This is generally possible in the common case where the file's atomic elements (e.g. records) are small compared to the block size of the DFS. Since typical data elements are on the order of 1000 bytes, and typical DFS blocks are on the order of 100 MB, it is often possible to compute a list of Positional splits 1402 that cover the input files while also ensuring that each Positional split's offset and length are very close to some file block's offset and length.

Because most Positional data splits 1402 can be calculated such that their boundaries are close to file block boundaries 1401, 1402, the software can associate each Positional split 1402 with its closely-matching file block(s) 1401. Given the resulting Positional splits 1402 and their associated file blocks, the software may then map, illustrated by interconnections 1403, each Positional data split 1402 to a Task 1404, which is a unit of computation that reads only the associated Positional split but which otherwise performs identical computation to every other such similarly-defined Task 1404. By doing so, and then dispatching each Task to be processed by the DCS, the software may achieve data-level parallelism on the Cluster for faster processing.

Furthermore, the software may use the node list associated with each file block to suggest to the DCS that each Task 1404 should be executed on a worker node 1406, utilizing a task-to-worker node affinity map 1405, that is one of the nodes of the Cluster that physically stores the data block associated with the Task 1404. This is known as “execution affinity”. In this example, Task1 is mapped to Worker Node2, Task2 is mapped to Worker Node5, and Task3 is mapped to Worker Node3. To the extent that the DCS is capable of honoring such execution affinity requests, the distributed computation will be more efficient, as each Task 1404 will be able to read data from node-local storage instead of requesting the data from another worker node that stores the file block. This assumption is predicated on the observation that currently-available computer hardware can read data from local storage faster than it can retrieve it across a network switch from another computer. Software may perform various optimizations on the Task 1404 worker node affinity mapping 1405 to improve throughput and load balancing on the Cluster.

The software may utilize map 1403 to direct several Positional splits 1402 to a single Task 1404, and continue to achieve execution affinity benefits, provided that all blocks of each Positional split 1402 are stored on the same node. Google's Page Rank computations and the Hadoop Map-Reduce software are a notable examples software that follows these principles to achieve scalability of computation on large data sets. However, there are situations where user interfaces are somewhat awkward, and certain applications can be time-consuming to implement and to execute satisfactorily.

Many data-processing applications require that the atomic elements of data (e.g. records) be sorted on some subpart of the data elements (the “keys”). While there are many approaches to sorting, some achieve better performance than others in a DFS+DCS environment, using some variation of what might generally be called “distributed sorting”. This discussion assumes that the data to be sorted is already stored in the DFS. There are many implementations of distributed sorting, but most of them contain steps and involves software elements represented by Distributed Sorting System 1500, FIG. 5, which creates a mapping, represented by interconnections 1502, from Positional splits 1501 onto Sort Tasks 1503. The data to be sorted, which resides on the DFS, is divided into Positional splits 1501, which cover files to be sorted, and such Positional splits 1501 are mapped onto Sort Tasks 1503, as described above for Tasks 1404, FIG. 4, for example. Each Sort Task 1503, FIG. 5, has the job of sorting its Positional split 1501 by the specified keys. The result of each Sort Task 1503 may be held in memory (if sufficient memory is available), or written to the local file system of the worker node running the Sort Task 1503, or written to the DFS. The result of this step is a set of sorted data blocks 1504, one or more per Sort Task 1503, shown as Sorted data1, Sorted data2 and Sorted data3 in this example. In addition, this step creates a set of key samples 1505, one per sorted data block 1504, which assist in the analysis of optimal key-range splits. A key sample 1505 is produced as a side-effect of block sorting operations or when loading already-sorted data into the DFS by sampling every Nth sorted data element, wherein a typical value for N is 1000. Each key sample 1505 typically contains a plurality of tuples, each tuple including a set of the partition key values of the sampled data elements, plus the offset into the corresponding sorted data block where the record is written.

After blocks are sorted, a key-range analyzer 1506 analyzes all key samples, as provided by pathways 1522 shown as dashed lines, and produces a list of non-overlapping key range splits 1507 that collectively cover the range of possible key values. A key range split 1507 is a logical subset of data defined by a range of partition key values, contains the lower and upper bounds of partition key values for the range, and may also contain one or more position hints to assist in locating the first data element of the key range split more efficiently. It is desirable that each key range split 1507 represents a roughly-equal number of data elements. Some software skips the analysis of key distribution step, instead using a priori knowledge of the data or heuristics to produce key ranges without producing or examining key samples 1505. The number of key ranges is equal to the number of Merge Tasks 1508.

Each key range described above is mapped onto one of several Merge Tasks 1508, as indicated by mapping pathways 1524, each of which reads all sorted data blocks 1504 (or at least those which are known to contain data within its key range), as indicated by interconnections 1520, reading and merging the data from each sorted data block 1504 that matches its assigned key range. The Merge Tasks 1508 may utilize “hints” from the Sort Tasks 1503, or a priori knowledge, to predict the position in each sorted data block 1504 where its range of keys is to be found and thus reduce the amount of time spent searching for the start of the key range. The Merge Tasks 1508 typically write the merged data to a set of sorted files 1509 in the DFS or local file system, one file per Merge Task. Taken as a whole, the sorted files 1509 contain a global ordering of the data elements. Some systems may support writing all merged data into a single logical file simultaneously, but the end result is the same for most practical purposes. Alternatively, each Merge Task may stream the sorted data directly to subsequent processing steps 1510, avoiding file system writing and reading. In the above distributed sorting model, the number of Positional splits 1501, Sort Tasks 1503, and Merge Tasks 1508 is variable for performance-tuning purposes, as it the choice of writing to the results to sorted files 1509 versus streaming the data to subsequent processing steps 1510.

As described below, the scope of the present invention is not limited to this specific instance of distributed sorted techniques. There are many variations on this model of distributed sorting, most of which have been described or implemented in prior art. For example:
Storing intermediate results in memory, versus local file system storage, vs. the DFS.
Scheduling Merge Tasks 1508 before all Sort Tasks 1503 have completed, to increase aggregate throughput.
Segmenting a.k.a. partitioning. Less computationally expensive than sorting, instead of producing output data that is globally ordered, it guarantees that all data elements containing the same key values are mapped onto the same Task or stored in the same file, without achieving global sort order. In this topology the Merge Tasks 1508 are replaced by key-range-reader tasks, which read, but do not perform an ordered merge of, the data elements contained in the assigned key range.
Segmenting or partitioning without a key sample analysis. Some approaches omit the key-sample analysis and instead compute a hash on each key modulo the number of reader tasks. This approach is simpler but can lead to issues of task size imbalance (a.k.a. “data skew”).

It is therefore desirable to have an improved data management system which is more user-friendly, quicker to implement, and faster to execute.

### SUMMARY OF THE INVENTION

An object of the present invention is to provide an improved data management system and method which generates clean, integrated, actionable data.

Another object of the present invention is to provide such a system and method which generates such data more quickly, more reliably and at a lower overall cost.

This invention features a computer-implemented system and method for performing data-processing in a computing environment having a file system (FS) and a computing system (CS), preferably including at least one processor and at least one memory storage unit, to process at least one original Directed Graph (DG) having multiple edges and vertices. The DG includes (a) at least one input vertex representing a source of data elements from the FS with each input vertex having at least one attribute that specifies data element processing constraints, (b) at least one output vertex representing a destination of data elements, and (c) at least one transform vertex representing at least one transformation operation on the data elements. The system and method analyze and condition data elements available from the DG input vertices, and customize the original DG into at least one customized DG including, for each DG to be customized: (i) replacing each input vertex with a customized input vertex that reads at least a portion of at least one of (1) original input data and (2) data that results from a selected conditioning strategy; and (ii) replacing each output vertex with a customized output vertex that writes at least a portion of the data. A list of Tasks is created for execution in the CS wherein each Task processes at least a portion of the customized DG in some embodiments and, in other embodiments, each Task processes at least one customized DG. The Tasks are delivered to the CS for processing in an execution engine capable of performing requested data transformations in the computing environment.

In certain embodiments, the FS is a distributed file system (DFS), the CS is a distributed computing system (DCS), the DFS includes at least one interconnected storage medium, and the DFS and the DCS are interconnected with each other. In some embodiments, the DFS includes at least one interconnected storage medium and the DCS is a computing system including at least one interconnected processor and at least one interconnected memory storage unit. Preferably, the DFS and the DCS are also interconnected with each other. In certain embodiments, the step of analyzing and conditioning data elements includes constructing tasks that run on the DCS. In a number of embodiments, the system includes the execution engine which is capable of accurately executing semantics defined by each DG. In some embodiments, processing is distributed among a plurality of nodes and the computing environment is a parallel computing environment. In certain embodiments, the system is data-locality aware, scheduling tasks on nodes that contain data blocks to optimize performance.

In certain embodiments, worker affinity is assigned to at least some of the tasks. In some embodiments, selecting a conditioning strategy includes constraining at least some of the input vertices of the DG by at least one parameter specified by a user. In one embodiment, constraining includes a splitting constraint which limits how data elements from each input are divided and, in another embodiment, constraining includes requiring data elements containing the same key values to be assigned to the same task. In some embodiments, each division is mapped onto a task. In certain embodiments, the system and method further include specifying a list of at least one of partition key fields and a partition type. In one embodiment, the key fields and other data are produced by an arbitrary transformation, specified in terms of a sub-DG, and the input data. In another embodiment, each input is analyzed to determine which strategy must be followed to condition the input data for processing in order to meet the user-specified input constraint, such as choosing the conditioning strategy for an input based upon at least one of: a user constraint; user partition key fields; user partition type; whether the data already resides in the DFS; and whether the data is already sorted on the partition keys. In another embodiment, the chosen conditioning strategy is to do nothing if the input data is already stored in the DFS and there are no user-specified partition keys. In yet other embodiments, the chosen conditioning strategy is to (i) load the input data to a file in the DFS or (ii) sort the data by the user-specified partition keys as it is loaded into the DFS.

Some embodiments further include generating a set of sorted block files and corresponding Key Sample Files with every Nth sorted data element being sampled, said Key Sample Files containing tuples that include the partition key values of the sampled data elements, plus the offset into the corresponding sort block file where the data element is found expressible as tuples: {file, offset, key1 . . . keyN}. One embodiment further includes choosing the conditioning strategy to sample already-sorted data as it is loaded into the DFS, producing a single sorted data file and corresponding Key Sample File.

In a number of embodiments, the chosen conditioning strategy is to produce a set of sorted chunk files for unsorted data already residing in the DFS, including sorting the data by the user-specified partition keys. In one embodiment, corresponding Key Sample Files are produced for the set of chunk files, and the set of sorted chunk files and Key Sample files are produced by a set of parallel tasks running in the DCS. In other embodiments, the result of the chosen conditioning strategy is to create a table of split positions, which are tuples of the form {offset, key1 . . . keyN} where “offset” of each tuple is the position of the first data element containing the key values key1 . . . keyN in the already-sorted Input data file and “key1” . . . “keyN” are the partition key values copied from the data element. In one embodiment, the table is created by querying the DFS to obtain the total size of the input data, creating a list of approximate split positions in the input data, choosing such split positions so as to create a list of divisions whose size is appropriate for assignment to a list of Tasks on the cluster, performing a search in the sorted input data to locate an exact split position near each approximate split position, omitting unsuitable split positions, and combining the results of all split position processing.

In certain embodiments, an analysis of the data may produce a list of “Key Range Splits,” said Key Range Split being a subset of data defined by a range of key values. In one embodiment, the Key Range Split is stored as a tuple. In another embodiment, the Inputs are analyzed depending upon the user constraint and the conditioning strategy used on the input, the results being a list of Key Range Splits that divide, as evenly as practical, the data elements of the analyzed input into roughly-equal numbers of data elements. In yet other embodiments, an analysis of data produces a list of Positional Splits, said Positional Splits being a subset of data defined by a list of positions and lengths. In one embodiment, the list of tasks is determined by dividing the list of Positional Splits between the tasks, and the Tasks mirror the Positional Splits that are produced by the processing and data processing analyses. In another embodiment, the Tasks mirror the Key Range Splits that are produced by the processing and data processing analyses.

In a still further embodiment, Task selection is driven by determining the largest input with the user selected constraint. In one embodiment, the DG is customized with one or more input vertices being replaced with similar input vertices that read only the list of Positional splits specified, each Task being associated with a list of Positional splits for the largest such input vertex. In another embodiment, the DG is customized with one or more input vertices being replaced with customized input vertices that read only the Key Range Split specified, each Task being associated with a Key Range Split for the largest such input vertex. In one embodiment, the customized vertices read from a list of pre-sorted files, beginning at a suggested offset in each file, reading only data elements whose partition keys fall within a Key Range Split, using a priority queue or similar mechanism to merge data elements simultaneously from all sources, outputting a series of sorted data elements to output edges in the DG, ignoring all data elements sorting before the Key Range Split, and ceasing to read each file when said file reaches the end or upon reading a data element sorting after the said Key Range Split. In other embodiments, the customized vertices read from a pre-sorted file, starting at a suggested offset in the file, reading only data elements whose partition keys fall within a Key Range Split, reading data elements sequentially from the file, ignoring all data elements sorting before the Key Range Split, ceasing to read the file at the end of the file or upon reading a data element sorting after the Key Range Split, and writing all data elements to the output edges in the DG. In one embodiment, the pre-sorted file is a set of files read by the vertex resulting in a pre-sorted list of data elements.

In yet another embodiment, the customized vertices read data elements from a list of pre-sorted files, starting at a suggested offset in each file, and reading only data elements whose partition keys fall within a Key Range Split. It may read data elements sequentially or in parallel from all sources, outputting a series of unordered data elements to its output edges in the DG, ignoring all data elements sorting before the Key Range Split, and ceasing to read each file when that file reaches the end or upon reading a data element sorting after the Key Range Split. In one embodiment, the vertex customization results in the creation of a list of customized DGs, each DG being assigned to a Task for execution. In another embodiment, execution affinity is deemed beneficial for Tasks created from Positional splits. In certain embodiments, the DCS includes Hadoop YARN software and the DFS includes a Hadoop Distributed File System.

### BRIEF DESCRIPTION OF THE DRAWINGS

In what follows, preferred embodiments of the invention are explained in more detail with reference to the drawings, in which:

FIGS. 1A-1E are schematic diagrams of types of prior art Directed Graphs (DG) including components thereof;

FIGS. 2A-2F are schematic diagrams of components of a prior art Distributed File System (DFS) and a Distributed Computation System (DCS) with network interconnect to a plurality of Worker Nodes;

FIG. 3 is a schematic diagram of an example of prior art file blocks as mapped to worker nodes;

FIG. 4 is a schematic diagram of an example of prior art mapping of file blocks and positional splits to tasks with worker affinity;

FIG. 5 is a schematic diagram of a prior art distributed sorting model utilizing keys;

FIG. 6A is a schematic diagram of an embodiment of a system according to the present invention interacting with a computing environment;

FIG. 6B is an overview of another embodiment of a system and method according to the present invention showing a representative sequence of operation;

FIG. 7 is a flow chart of an input strategy analyzer;

FIGS. 8A-8C are flow charts of an input strategy executor;

FIG. 8D is a schematic flow chart for constructing a Sort Task function;

FIG. 9A is a schematic block diagram of an input split analyzer;

FIG. 9B is a flow chart of an input split analysis decision;

FIG. 9C is a schematic block diagram of a positional split analyzer;

FIG. 9D is a flow chart of positional analysis by the positional split analyzer;

FIG. 9E is a schematic block diagram of a binary search analyzer;

FIG. 9F is a flow chart of analyzing binary search by the binary search analyzer;

FIG. 9G is a schematic block diagram of a sample analyzer;

FIG. 9H is a flow chart of analyzing the sample by the sample analyzer;

FIG. 10A is an overview block diagram of a DG Customizer;

FIG. 10B is a schematic flow chart of replicating and customizing a DG by the DG Customizer;

FIG. 10C is a schematic diagram of generating one or more DG Replicas by the DG Replicator;

FIG. 10D is a schematic diagram of a DG Input Customizer;

FIG. 10E is a schematic diagram of customizing Key Range Splits;

FIG. 10F is a schematic diagram of customizing Positional Splits;

FIG. 10G is a schematic diagram of Customize Splitting=None;

FIG. 10H is a schematic diagram of a DG Output Customizer;

FIG. 11 is a schematic diagram of a DG Executor interfacing with a DCS Master to process customized DG replicas according to the present invention; and

FIGS. 12A-12E are schematic flow charts for implementing customized input vertices of PositionalSplitReader, KeyRangeMerger, KeyRangeReader, and KeyRangeCombiner, respectively.

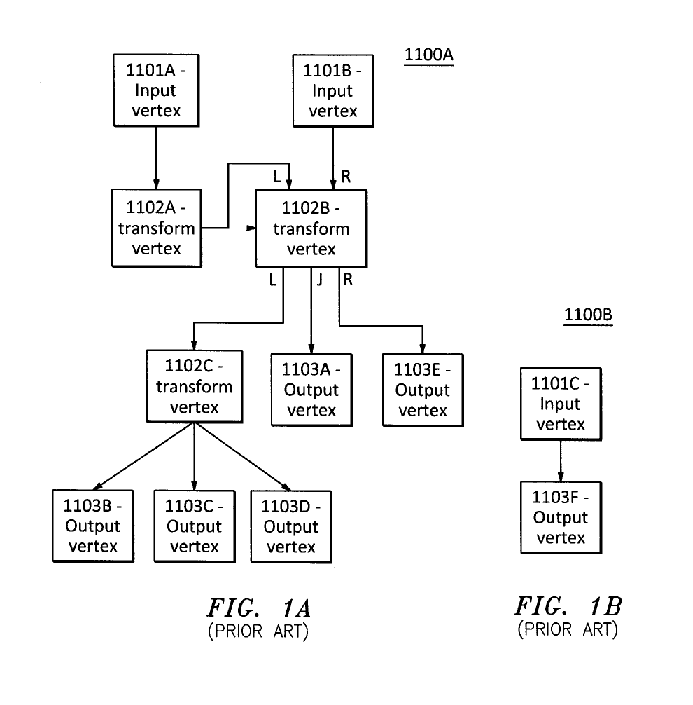

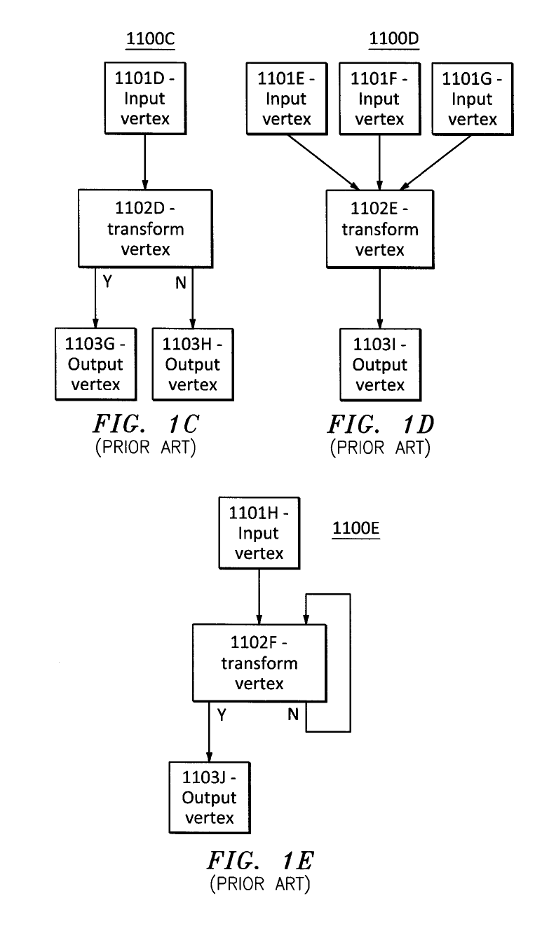

### DETAILED DESCRIPTION OF THE PRESENTLY PREFERRED EMBODIMENTS

This invention may be accomplished by a computer-implemented system and method for performing data-processing in a unitary or parallel computing environment having a file system (FS) such as a distributed file system (DFS) and a computing system (CS) such as a distributed computing system (DCS), typically including one or more processors and at least one main memory storage unit, to process at least one original Directed Graph (DG) having multiple edges and vertices. The DG includes at least one input vertex representing a source of data elements from the FS with each input vertex having at least one attribute that specifies data element processing constraints. The DG further includes at least one output vertex representing a destination of data elements, and at least one transform vertex representing transformation operations on the data elements. Preferably, the input vertices of the DG are able to be constrained by one or more parameters specified by a system user. The system and method analyze and condition data elements available from the DG input vertices, and are capable of customizing the original DG into at least one customized DG. For each DG to be customized, the system and method: (i) replace each input vertex with a customized input vertex that reads at least a portion of at least one of (1) original input data and (2) data that results from a conditioning strategy; and (ii) replace each output vertex with a customized output vertex that writes at least a portion of the data. A list of Tasks is created for execution in the CS wherein each Task processes at least a portion of the customized DG. In some constructions, worker affinity is assigned to the Tasks if such an assignment may be beneficial. The Tasks are delivered to the CS for processing in an execution engine capable of performing requested data transformations in the computing environment.

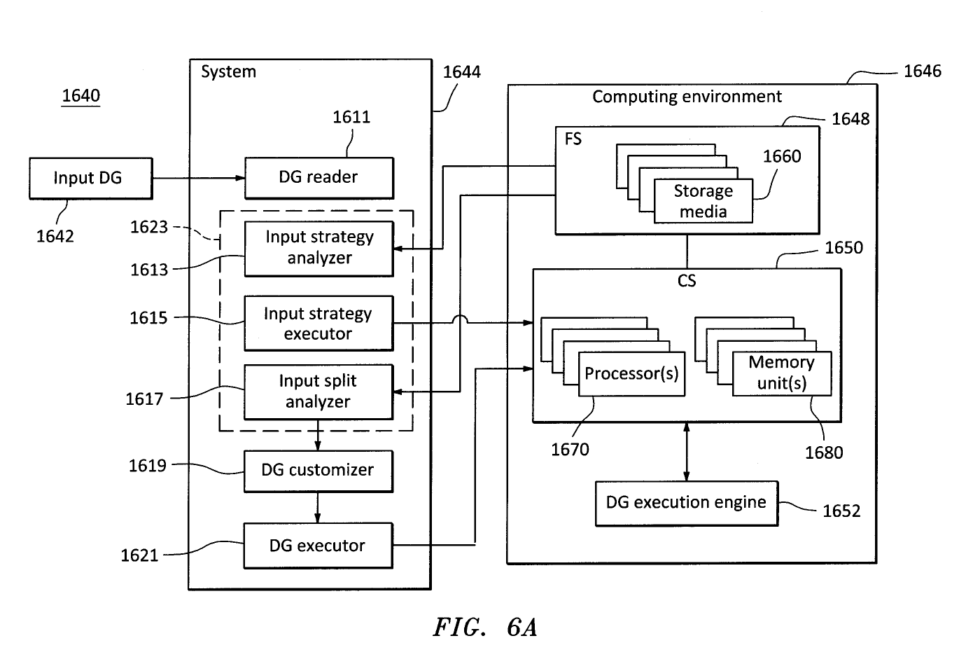

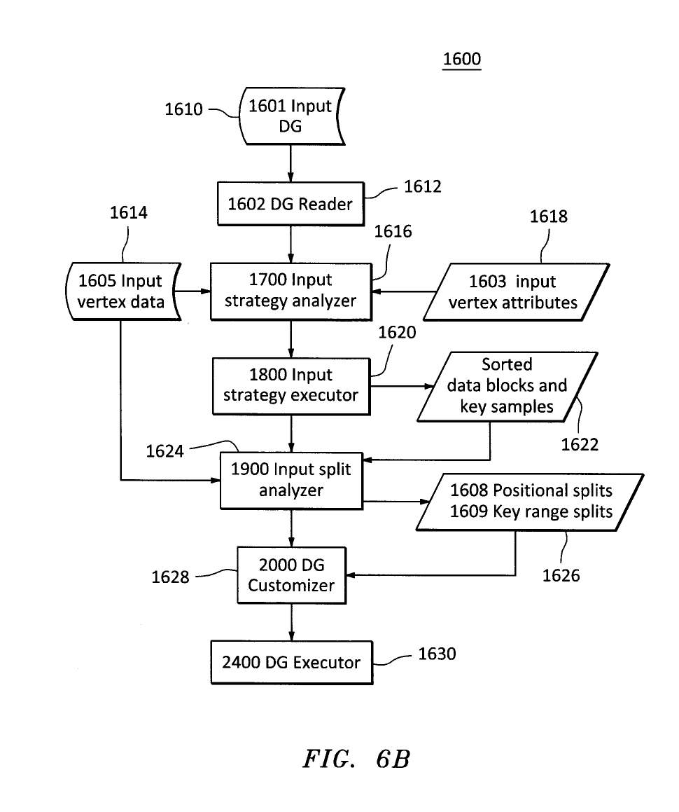

One construction of a computer-implemented architecture 1640 according to the present invention is illustrated in FIG. 6A having a set 1642 of original DG (Directed Graph), also referred to as Input DG, received by a system 1644 according to the present invention having a DG reader module 1611, an Input strategy analyzer module 1613, an Input strategy executor module 1615, an Input split analyzer module 1617, a DG customizer module 1619, and a DG executor module 1621. In one construction, modules 1613, 1615 and 1617 are implemented by an analysis and conditioning module 1623 as indicated by the dashed line in FIG. 6A. Architecture 1640 further includes a computing environment 1646 which is a unitary environment in some constructions and, in other constructions, is a parallel environment. The environment 1646 includes a FS (File System) 1648, a CS (Computing System) 1650, and a DG execution engine 1652. In some constructions, the FS 1648 is a DFS (Distributed File System) and the CS 1650 is a DCS (Distributed Computing System). DFS 1648 typically includes one or more storage media 1660. DCS 1650 includes one or more processors 1670 and one or more memory units 1680.

In some constructions, system 1644 includes at least one non-transitory computer-readable recording medium having instructions, such as application executable code, to implement techniques according to the present invention as described in more detail below. In other constructions, system 1644 is incorporated into the parallel computing environment 1646. In yet another construction, all of architecture 1640 is hosted in a unitary computing environment.

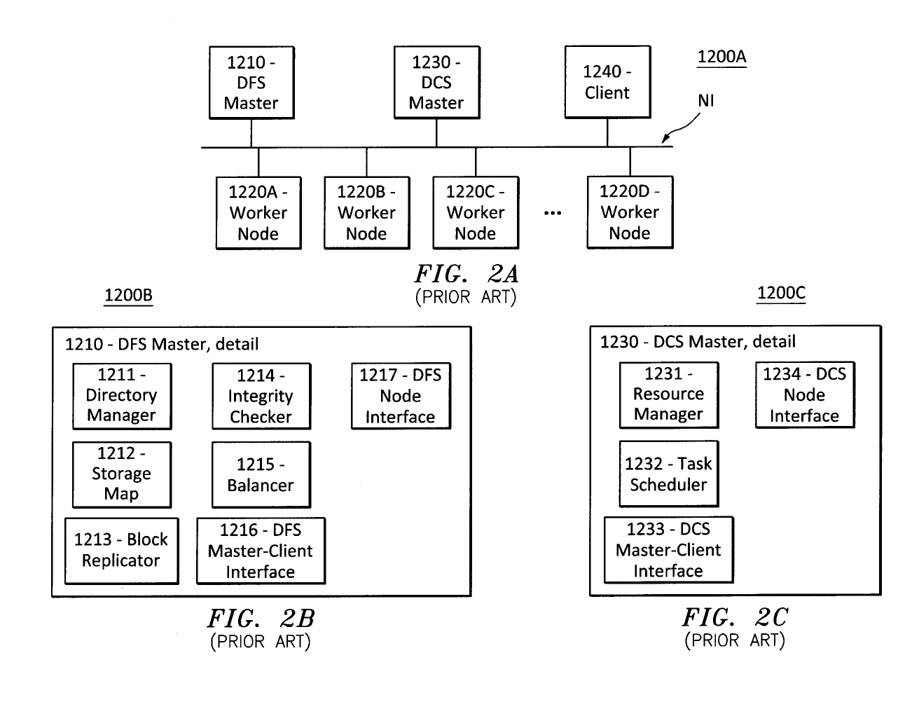

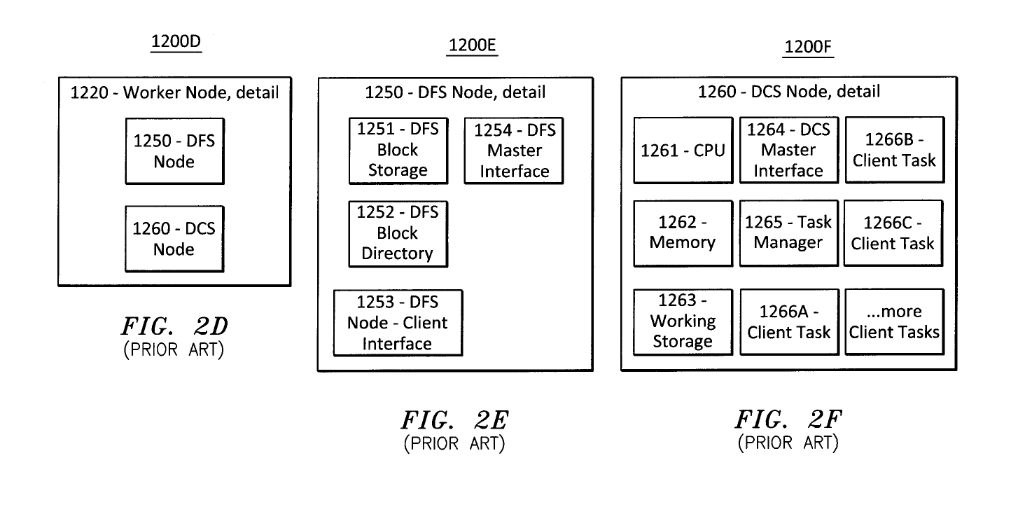

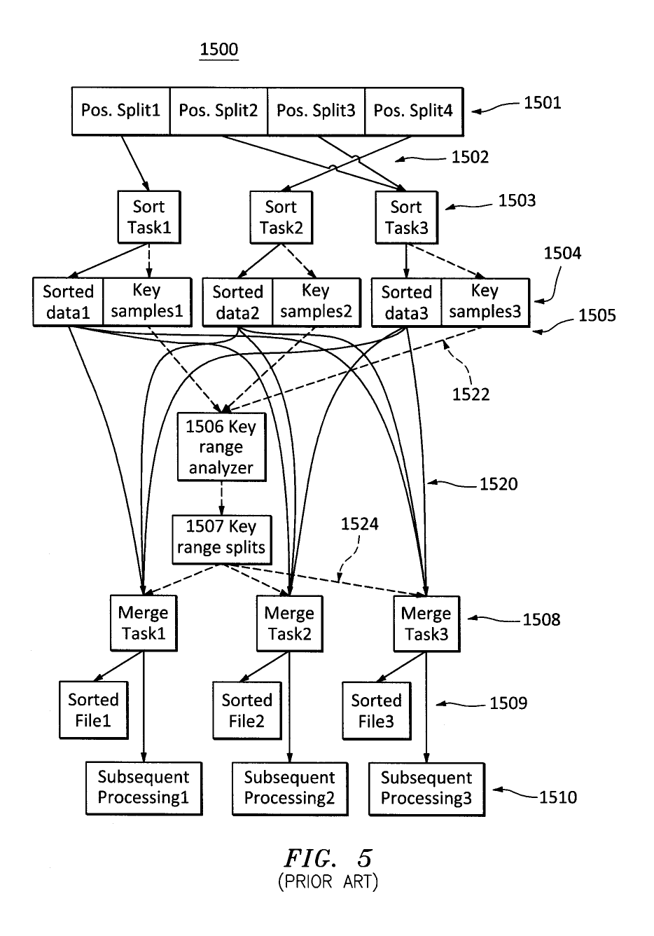

Another system and method 1600 according to the present invention, FIG. 6B, includes distributing the data-processing defined by one or more original DG in set 1610, also referred to herein as an Input DG 1601, and achieving scalability with a minimum of effort on the part of the software's user. The method assumes the presence of a DFS and DCS, such as described above in relation to DFS and DCS 1200, FIGS. 2A-2F. While the present application speaks of the DFS and DCS as if they are co-located, that is not a necessary condition of the invention. In one construction as illustrated in FIG. 6B, the system and method includes:
An input DG 1601 specifying a set of inputs, transformations, and outputs. A DG Reader 1602, module 1612, is a software system which can interpret the structure of the input DG 1601.
User-specified input vertex attributes 1603, set 1618, which specify how data elements from each input vertex of the input DG 1601 may be split and grouped for parallel execution.
An input strategy analyzer 1700, module 1616, which analyzes the input DG 1601, input vertex attributes 1603, and input vertex data 1605, set 1614, and chooses of one of several input conditioning strategies for each input vertex.
An input strategy executor 1800, module 1620, which executes one of several strategies on the data of each input vertex of the input DG 1601 and which may produce one or more sorted data blocks and/or key samples, set 1622, which are similar in some constructions to data blocks 1504 and key samples 1505 described in relation to FIG. 5 above.
An input split analyzer 1900, module 1624, further analyzes the data of each input vertex and input vertex attributes 1603, set 1618, and any key samples 1505, set 1622, produced by the input strategy executor 1800, module 1620, producing a list of Positional splits 1608 or Key Range Splits 1609, set 1626.
A DG Customizer 2000, module 1628, creates customized replicas of the input DG 1601 by replacing input vertices with customized, novel vertices capable of reading Positional splits or Key Range Splits as indicated by prior analysis, and further customizes each DG replica by replacing output vertices with customized, novel vertices capable of writing output fragments.
A DG Replica executor 2400, also referred to as DG Executor 2400, module 1630, which assigns the set of customized DGs 2103 to DG Tasks 2401, and executes the DG Tasks 2401 on the DCS 1200.

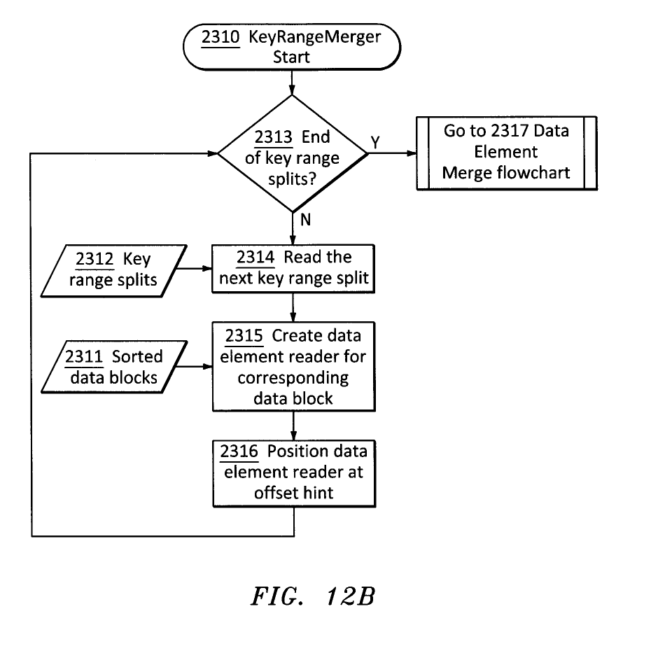

The user may specify a set of attributes 1603 for each input vertex of the Input DG 1601. These input attributes include:
Splitting constraint: The user may specify limits on how the data elements from each input are may be divided, where each division is mapped onto a DG Task 2401, FIG. 11. The possible splitting constraints are:
   None: The entirety of the data elements from this Input vertex must be read by each DG Task 2401.
   File: The data elements from this Input vertex may be split along file (or database segment) boundaries, and a DG Task 2401 may process sets of data elements comprising the entirety of one or more input files (or database segments).
   DataElement: The data elements from this Input vertex may be split along any data element boundary, and a DG Task 2401 may process any set of records that the system deems appropriate.
   Partition: The data elements from this Input vertex must be arranged and grouped such that all data elements containing the same key values are assigned to the same DG Task 2401. This concept may be generalized to support any DG-based transformation of the Input vertex data prior to partitioning (a.k.a. “computed keys”).
Partition keys: If the splitting constraint is “Partition”, the user also specifies the partition keys. For example, a user may desire to compare all data elements of a file that share the same ZIP code, in which case the user would specify the data field containing the ZIP code as the partition key. This concept may be generalized to support any DG-based transformation of the Input vertex data prior to partitioning, supporting “computed partition keys”.
Partition type: If the splitting constraint is “Partition”, controls whether the input must also be sorted within each partition. it is one of:
   Sort: Each DG Task 2401 will be assigned a subset of data elements such that the range of key values for each task does not overlap with the range of any other task, and the data elements read by each task are also ordered by the key fields.
   Segment: Each DG Task 2401 will be assigned a subset of data elements such that the range of key values for each task does not overlap with the range of any other task, but the data elements read by each task need not be ordered.

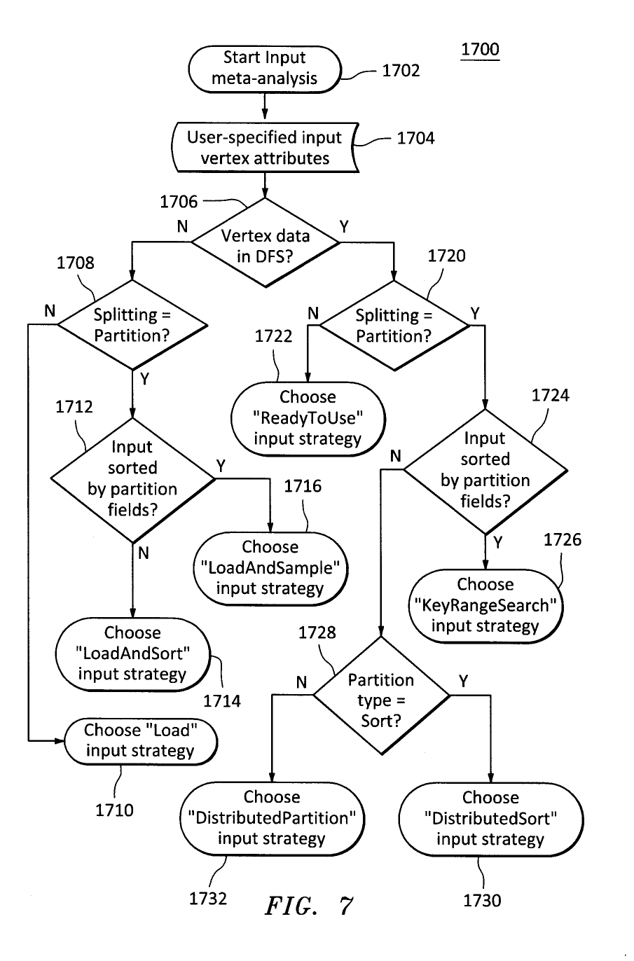

The input strategy analyzer module 1700, FIG. 7, examines the user-specified attributes 1603 of each Input vertex to determine which strategy should be followed to condition the input data for processing that will meet the logical constraints implied by the user-specified input attributes 1603. The correct strategy, that is, the optimum strategy for conditioning, is chosen based on these factors:
1. The user-specified splitting constraint (None, File, DataElement, or Partition).
2. The user-specified partition type (sort or segment). Only applicable when splitting=“Partition”.
3. Whether the data for an Input vertex already resides on the DFS or is coming from another source.
4. Whether the data for an Input vertex is already sorted on the partition keys.
   Combinations of these factors imply various choices of input strategy for each Input vertex of the input DG 1601, FIG. 6B. Choice of input strategy will also affect the customization of the input DG 1601 as replicas are created and assigned to each DG Task 2401, as described later.

In one construction, a technique implemented by the input strategy analyzer module 1700, FIG. 7, includes a Start Input meta-analysis, step 1702, and a User-specified input for vertex attributes is analyzed, step 1704. The system determines if Vertex data is in DFS, step 1706, and if not, then it is determined whether Splitting =Partition, step 1708, that is, whether the user selected the splitting procedure to be “Partition” instead of “None”, “File”, or “DataElement”. An input strategy of “Load” is selected, step 1710, if splitting does not equal partition. If splitting does equal partition, then it is determined whether Input is sorted by partition fields, step 1712. If not, then the system selects “LoadAndSort”, step 1714, as the input strategy; if Input is sorted by partition fields, then the system selects “LoadAndSample”, step 1716, as the input strategy.

If Vertex data is in DFS, step 1706, then the system determines whether Splitting =Partition, step 1720: if not, then the system chooses “ReadyToUse” as the input strategy, step 1722; if yes, then it is determined whether the Input is sorted by partition fields, step 1724: if yes, then the system chooses “KeyRangeSearch” input strategy, step 1726; if not, then it is determined whether the Partition type =Sort, step 1728. If yes, the system chooses “DistributedSort” as the input strategy; if no, then “DistributedPartition” is chosen as the input strategy, step 1732. Strategy designations such as “Load”, “LoadAndSort”, “LoadAndSample”, “ReadyToUse”, “KeyRangeSearch”, “DistributedSort” and “DistributedPartition” are referred to hereinafter by reference numbers 1710′, 1714′, 1716′, 1722′, 1726′, 1730′ and 1732′, respectively.

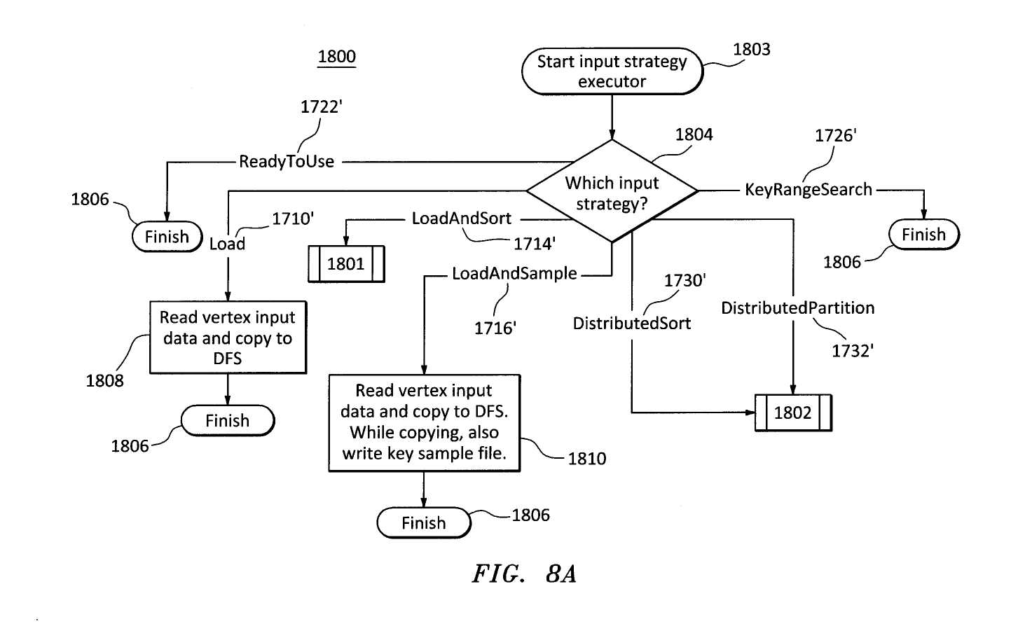

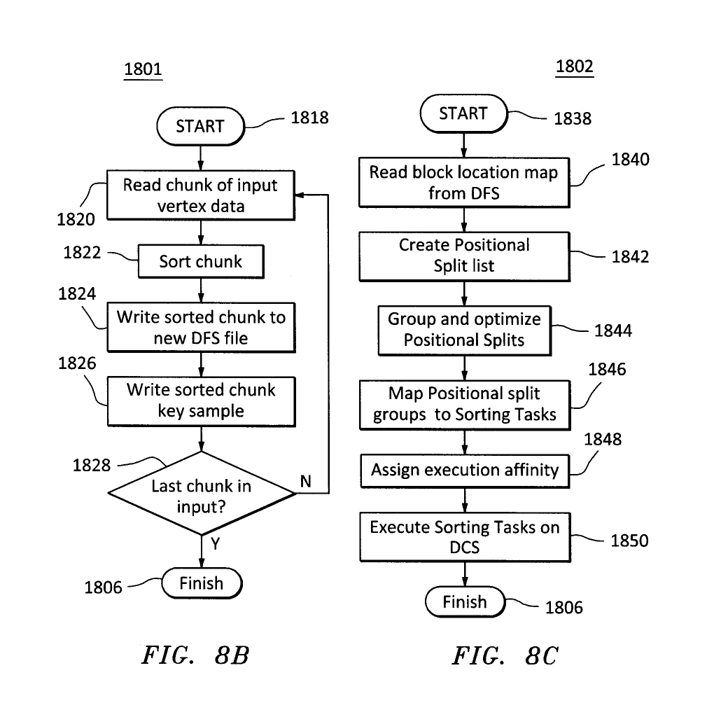

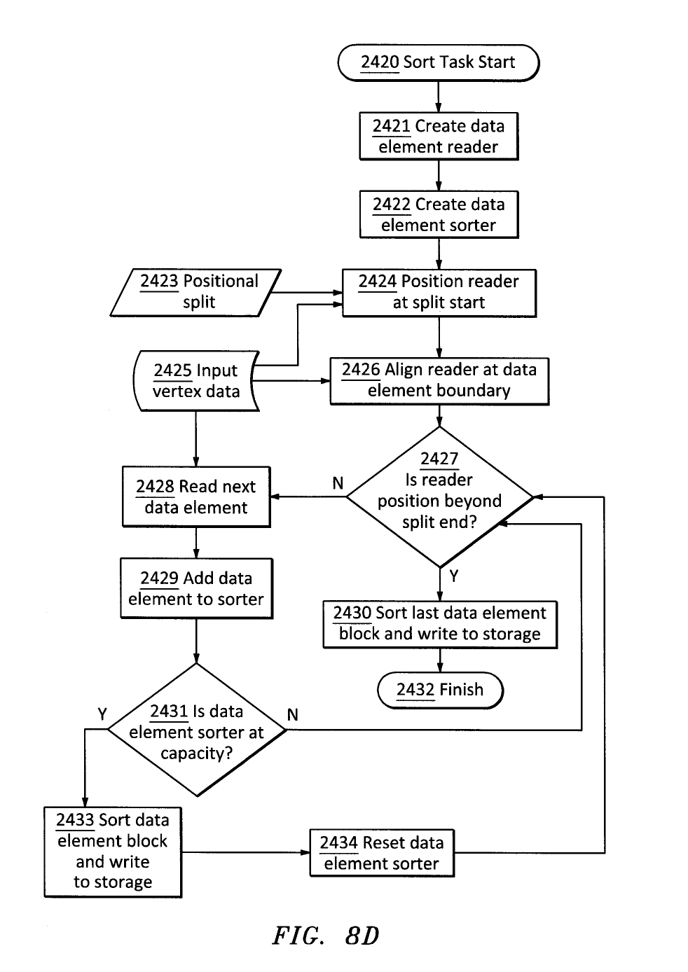

To optimize distributed execution of the input DG 1601, FIG. 6B, on a Cluster, each input vertex is assigned an input strategy. The input strategy executor module 1800, FIG. 8A, after being initiated, step 1803, takes appropriate steps to condition the input vertex data so that it is suitable for subsequent processing by DG Tasks 2401. The input strategy is determined, step 1804, and certain strategies such as ReadyToUse 1722′ and KeyRangeSearch 1726′, which require no further action, resolve directly to Finish 1806. For ReadyToUse 1722′, the Input vertex data is already in the DFS and nothing needs to be done. For KeyRangeSearch 1726′, the Input data is inside of the DFS and is already sorted on the partition keys. These types of strategy take no conditioning steps. For ease of illustration, the single end step of “Finish” 1806 is drawn in several locations in FIGS. 8A-8C.

The strategy Load 1710′ is handled by the system by reading vertex input data and copying it to DFS, step 1808, before Finish 1806. The Input vertex data is outside of the DFS and must be copied into the DFS for processing, but it need not be sorted. This strategy will include the following conditioning step: Copy the input data to a file in the DFS.

The strategy LoadAndSort 1714′ is handled by module 1801 as described below regarding FIG. 8B. The strategies, DistributedSort 1730′ and DistributedPartition 1732′ are handled by module 1802 as described below regarding FIG. 8C. The strategy LoadAndSample 1716′ is handled by reading vertex input data and copying it to DFS while writing key sample file, step 1810. The Input vertex data is outside of the DFS but it is already sorted. This strategy will include the following conditioning steps: Read the Input vertex data and write to a sorted data block in the DFS, such as data block 1504, FIG. 5, and then, while writing to the DFS, also sample the data and produce a key sample file such as file 1505.

Within module 1801, as illustrated in FIG. 8B, the Input data is outside of the DFS and will be sorted on the way into the DFS. This strategy of LoadAndSort 1714′ will include the following conditioning steps after start 1818:
Read the Input vertex data in chunks that will fit into memory, step 1820;
Sort each chunk by the user-defined partition keys, step 1822; and
Write each sorted chunk to a sorted data block 1504 in the DFS, step 1824. In one construction, for each sorted chunk, also write the corresponding key sample file 1505 in the DFS, step 1826.
   If the last chunk has not been processed, as determined at step 1828, the technique returns to step 1820. After the last chunk has been processed, the technique proceeds to Finish 1806. In some constructions, other techniques are utilized instead of key sample files to find appropriate key range divisions for one or more chunk files.

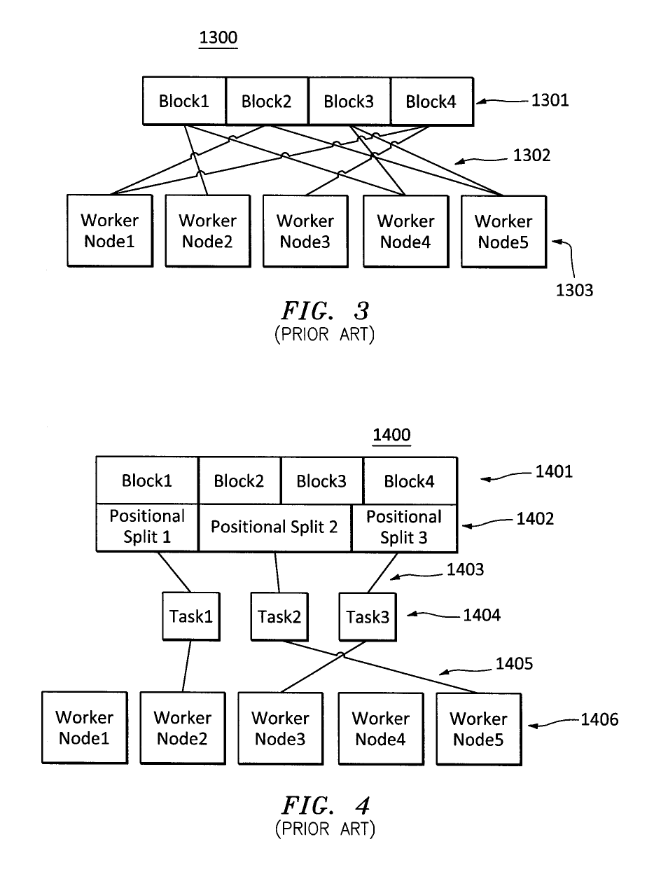

For the input strategy of DistributedSort 1730′, the module 1802, FIG. 8C, includes the following operations. The Input vertex data is inside of the DFS but is not yet sorted. This strategy will take the following conditioning steps after start 1838:
Obtain the list of file blocks, such as blocks 1301, FIG. 3, of the input vertex data from the DFS Master, such as DFS Master 1210, FIG. 2A, and the storage map 1302, FIG. 3, of worker nodes 1303 that store replicas of the file blocks, step 1840, FIG. 8C.
Derive a list of positional splits, such as Positional splits 1501, FIG. 5, from the file block list, step 1842, FIG. 8C. Positional splits generally follow file block 1301 boundaries, adjusting for necessities imposed by specific file formats, and allowing for multiple input files and files that are smaller than a DFS block size. Preferably, the positional splits are grouped and optimized, step 1844.
Map groups of Positional splits 1501 to Sort Tasks 1503, FIG. 5, the number of which is user-tunable, optimizing groupings so that a maximal proportion of file-block data referenced by the grouping is stored on a single DFS node such as node 1250, FIG. 2E, as part of step 1846, FIG. 8C.
Assign execution affinity to each Sorting Task 1503, step 1848, so as to maximize the likelihood that each such task will run on a worker node such as one of worker nodes 1220, FIG. 2D, that contains a DFS node 1250 that physically stores a maximal proportion of file-block data referenced by the Positional split grouping 1501 assigned to the Sorting Task 1503, FIG. 5.
Execute all Sort Tasks 1503 on the DCS 1200 as step 1850, FIG. 8C. Preferably, each

Sorting Task 1503 produces sorted data blocks 1504 and key samples 1505.

For the input strategy DistributedPartition 1732′, FIG. 8A, the Input data is inside of the DFS but is not yet sorted. This strategy will perform the same conditioning steps as the DistributedSort 1730′ strategy by module 1802, FIG. 8C.

In one construction, a Sort Task 2420 is created as indicated in FIG. 8D. The technique begins by creating a data element reader, step 2421, and a data element sorter, step 2422. The reader is positioned at split start, step 2424, while accessing positional split 2423 and input vertex data 2425. The reader is aligned at data element boundary, step 2426, which also accesses input vertex data 2425. If the reader is not positioned beyond split end, as determined at query step 2427, then the next data element is read, step 2428, from input vertex data 2425. The data element is then added to the sorter, step 2429, and it is determined whether the data element sorter is at capacity, query step 2431. If capacity has not been reached, then the technique returns to step 2427; if at capacity, then the data element block is sorted, step 2433, and written to storage. The data element sorter is then reset, step 2434, and the technique returns to step 2427. Once it is determined at step 2427 that the reader is positioned beyond split end, then the last data element is sorted and written to storage, step 2340, and the technique finishes, step 2432.

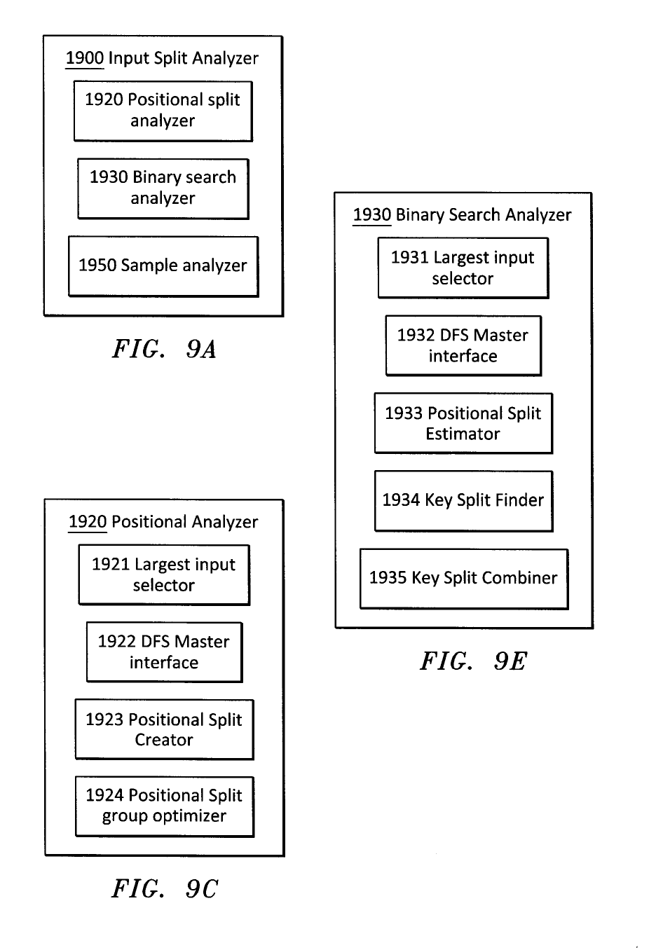

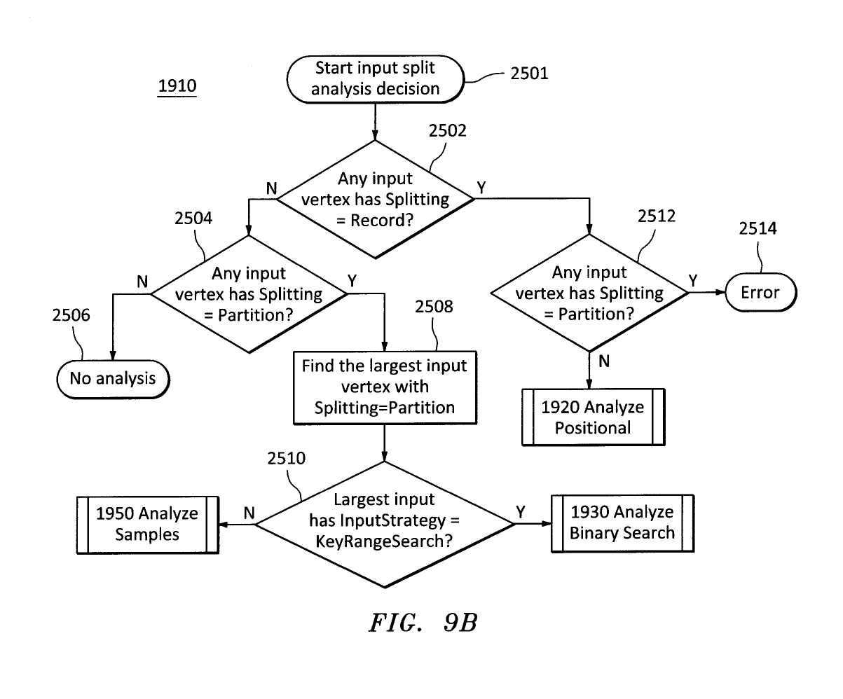

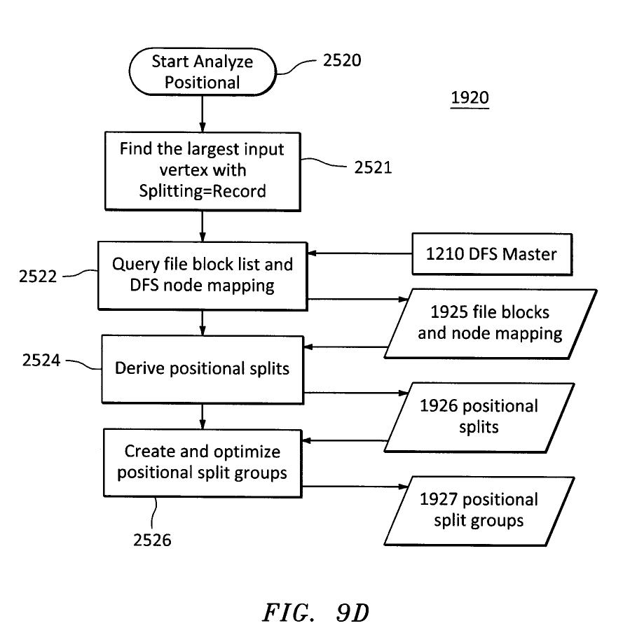

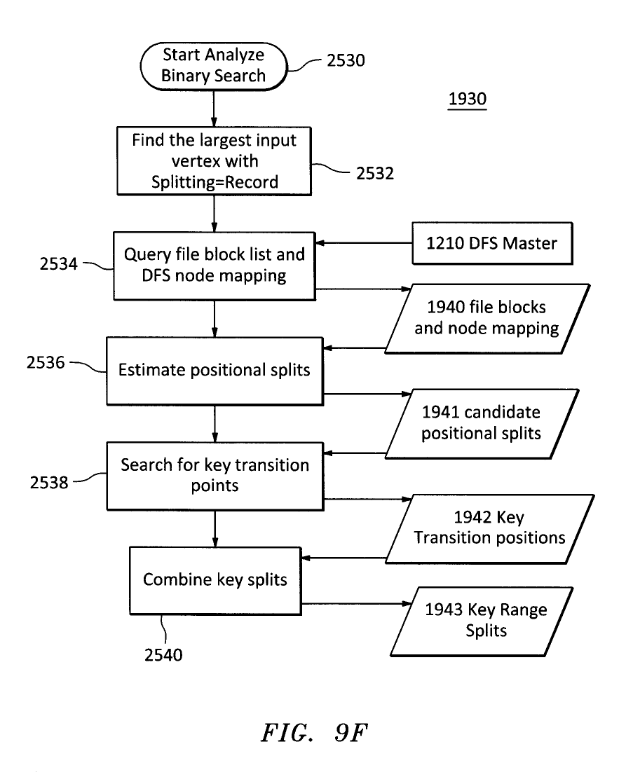

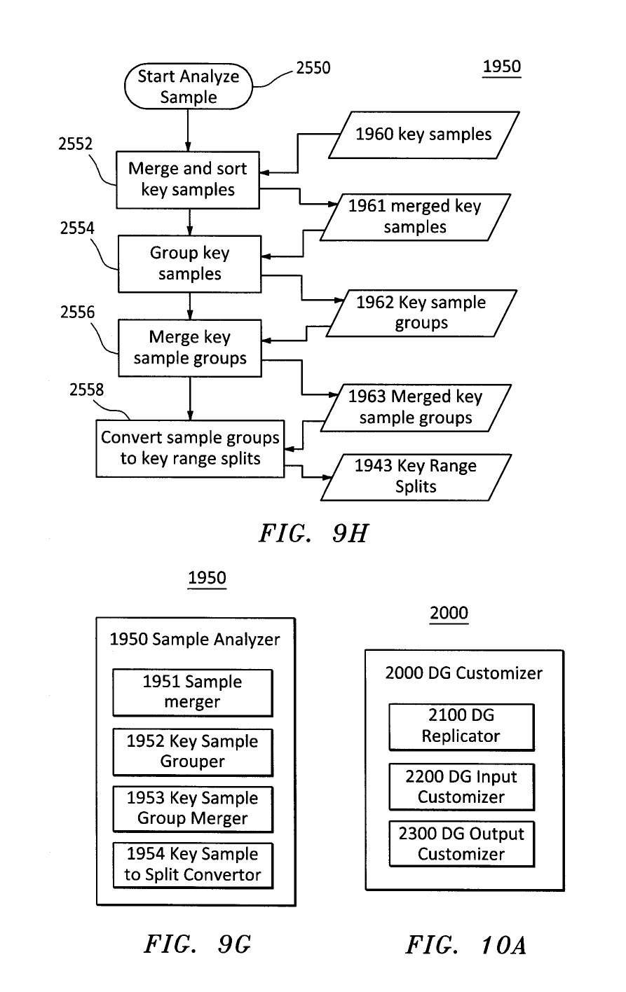

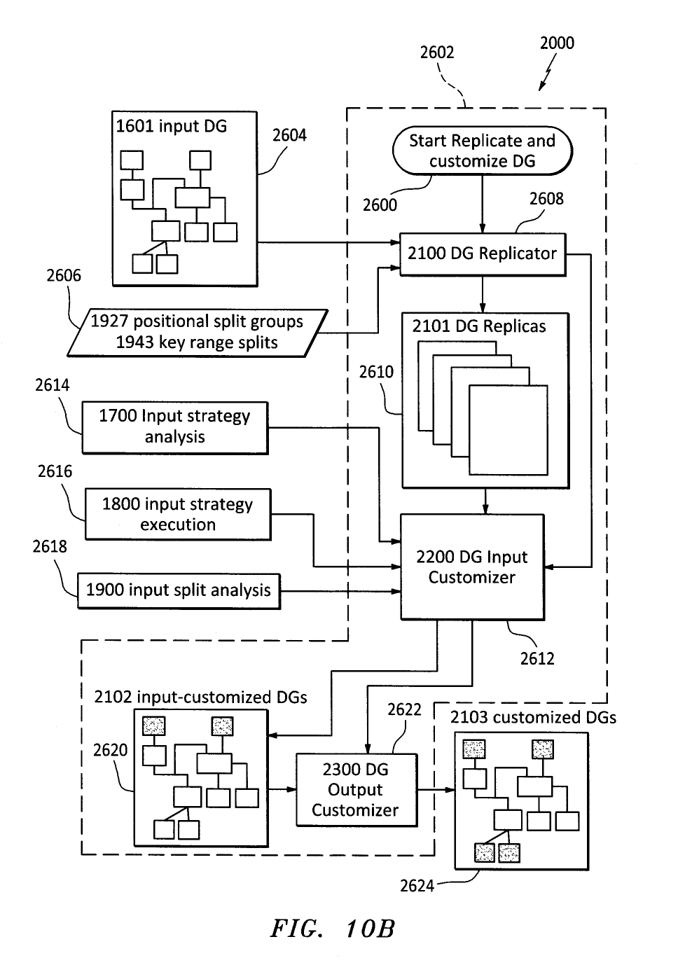

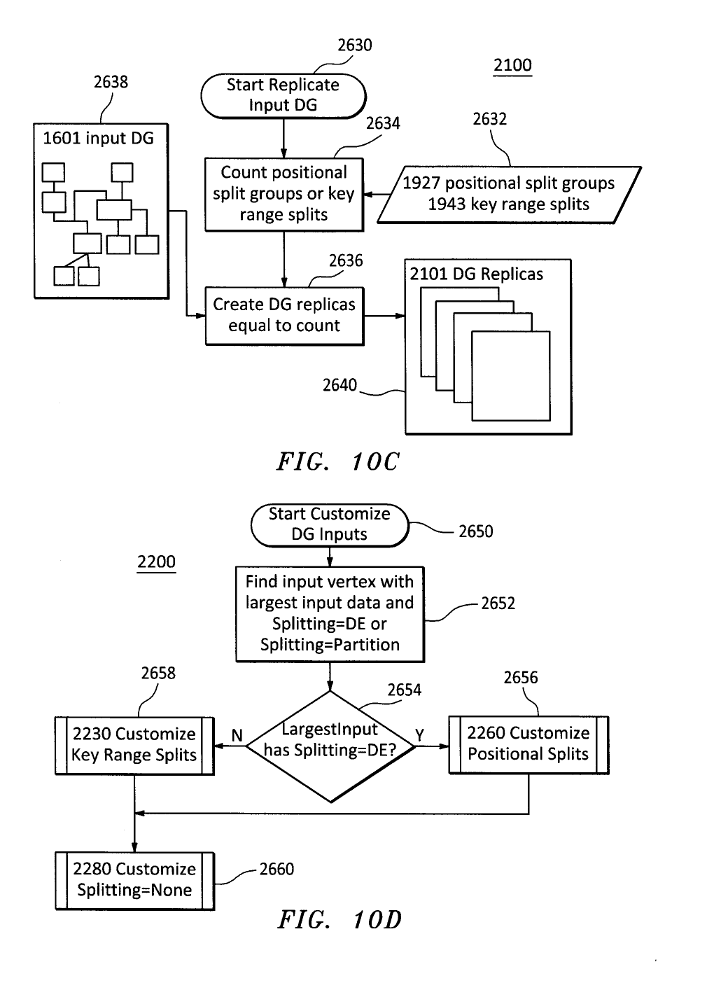

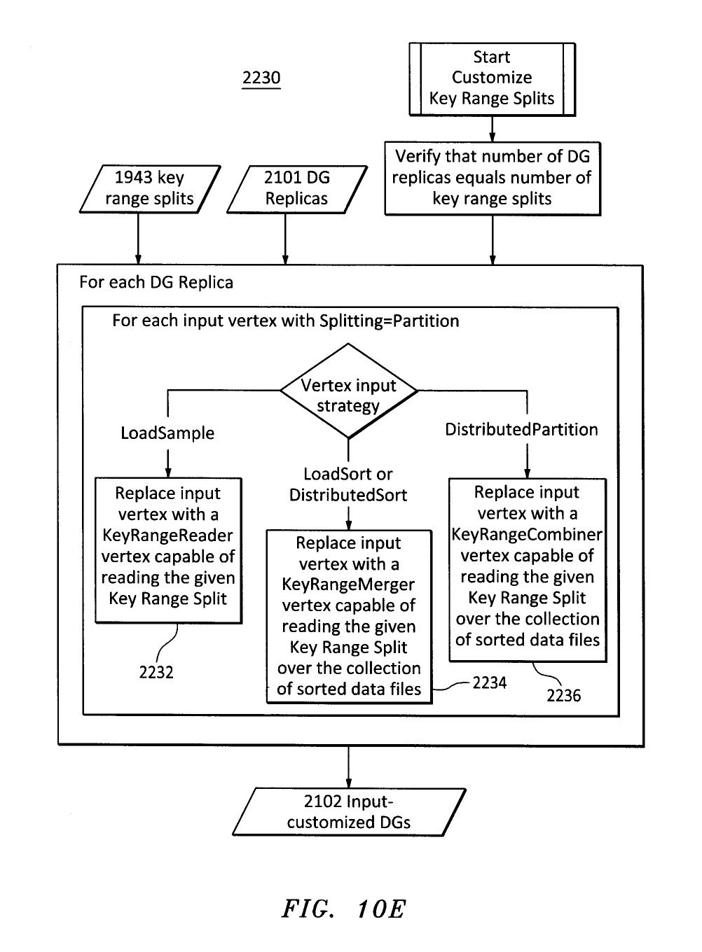

After input conditioning is complete, the input split analyzer module 1900, FIGS. 9A-9H, examines the user-specified input vertex attributes 1603, FIG. 6B, along with the results of the input strategy executor module 1800, FIGS. 8A-8C, to determine which input vertices will drive the subdivision of input data into DG Tasks 2401, to derive a set of positional splits or key range splits for such input vertices. In this construction, the input split analyzer 1900 includes an input split analyzer decision module 1910 that follows the technique described in FIG. 9B to choose an appropriate analyzer type, which when chosen follows one of the technique diagrams of FIGS. 9C-9H, for Positional Split Analyzer 1920, Binary Search Analyzer 1930, and Sample Analyzer 1950, respectively. In particular, the decision module 1910 is initiated, step 2501, and determines whether an input vertex has Splitting=DataElement, step 2502. If no, then no analysis is conducted, step 2506. If yes, then the system finds the largest input vertex with Splitting=Partition, step 2508, and it is determined whether the largest input has Input Strategy=KeyRangeSearch, step 2510. If no, then samples are analyzed, module 1950, as described in more detail below in relation to FIG. 9H. If yes, then Binary Search is analyzed by module 1930, such as described in relation to FIG. 9E.

If the input vertex does have Splitting=DataElement, then the system determines whether any input vertex has Splitting=Partition. If yes, then an Error message is generated, step 2514. If not, then the Positional Analyzer module 1920 is initiated, such as shown in FIG. 9C.

The positional analyzer module 1920, FIGS. 9C and 9D, is invoked as “Start Analyze Positional”, step 2520, in this construction when the largest input vertex has attributes 1603 set to Splitting=DataElement, and proceeds as follows:
The largest input selector module 1921, FIG. 9C, chooses largest Input vertex where Splitting=DataElement, step 2521, FIG. 9D, and names this vertex “LargestInput”.
The DFS Master Interface module 1922, FIG. 9C, queries the DFS Master 1210 in step 2522, FIG. 9D, to obtain a list of file blocks 1301 of the input data pertaining vertex “LargestInput”, and their mapping 1302 to nodes and stores this information in a file block 1925.
The Positional Split Creator module 1923, FIG. 9C, derives a list of Positional splits 1926, FIG. 9D, from the file block list 1925 in a step 2524. Positional splits generally but not always follow file block 1925 boundaries, adjusting for necessities imposed by specific file formats, and allowing for multiple input files and files that are smaller than a DFS block size. Positional split target size may be user-tunable and is related to the desired number of DG Tasks 2401.
The Positional Split Group optimizer module 1924, FIG. 9C, creates groups of Positional splits 1501, the number of groups being equal to the target number of DG Tasks 2401, optimizing groupings so that a maximal proportion of file-block data referenced by each grouping is stored on a single DFS node 1250, step 2526, FIG. 9D.
   This analysis strategy results in a list of Positional split groups.

The binary search analyzer module 1930, FIGS. 9E and 9F, is invoked when at least one input vertex has attributes 1603 with Splitting=Partition, and the data file(s) pertaining to the input vertex are already stored in the DFS and sorted on the partition keys. It proceeds as follows after initiation “Start Analyze Binary Search, step 2530:
The largest input selector module 1931, FIG. 9E, chooses largest Input vertex where

Splitting=DataElement, step 2532, FIG. 9F, and names this vertex “LargestInput”.
The DFS Master Interface module 1932, FIG. 9E, queries the DFS Master 1210 to obtain a list of file blocks 1301 of the input data pertaining vertex “LargestInput”, and their mapping 1302 to nodes and stores this information as file block list 1940, step 2534.
The Positional Split Estimator module 1933, FIG. 9E, derives a list of candidate positional splits 1941 from the file block list 1940 as step 2536, FIG. 9F. In one construction, positional split target count is user-tunable and is related to the desired number of DG Tasks 2401.
The Key Split Finder module 1934, FIG. 9E, discards the first candidate positional split 1941 at offset zero, and examines each remaining candidate positional split 1941, searching the input vertex's data on or before the candidate split offset to locate a new split offset such that the data element in the input vertex's data at or following the new split offset contains partition key values that differ from the partition key values of the next data element, step 2538, FIG. 9F, in doing so finding and storing a Key Transition Point 1942.
The Key Split Combiner module 1935, FIG. 9E, examines the set of Key Transition Points 1942, and removes any redundant transition points whose offsets are identical or out-of-order in a step 2540, FIG. 9F. In one construction, module 1935 then produces a set of Key Ranges Splits 1943 as follows:
   The first Key Range Split 1943 has a lower bound equal to the lowest possible partition key tuple, and upper bound equal to the first Key Transition Point 1942 and a “suggested offset”, also referred to as an “offset hint”, equal to zero.
   For the second and subsequent Key Transition Points 1942 create a Key Range Split 1943 with lower bound and an offset hint equal to the previous Key Transition Point 1942, and upper bound equal to the current Key Transition Point 1942.
   The last Key Range Split 1943 has a lower bound and an offset hint equal to the last Key Transition Point 1942, an upper bound equal to the highest possible partition key tuple.

The sample analyzer 1950 module, FIGS. 9G and 9H, is invoked when the input vertex with the largest data size has Splitting=Partition, and that input vertex's conditioning strategy was chosen to be LoadAndSort, LoadAndSample, DistributedSort or DistributedPartition. In one construction, after “Start Analyze Sample”, step 2550, it proceeds as follows:
The Sample Merger module 1951, FIG. 9G, reads all key samples 1960, FIG. 9H, such as key samples 1505, FIG. 5, produced by the input conditioning phase, merges and orders the key samples by partition key values in step 2552, FIG. 9H, and produces merged key samples 1961, which also records the source of each key sample.
The Key Sample Grouper module 1952, FIG. 9G, divides the merged key samples 1961 into a sample groups 1962 in a step 2554, FIG. 9H. In one construction, the number of sample groups 1962 is user-tunable and is related to the desired number of DG Tasks 2401, FIG. 11.
The Key Sample Group Merger module 1953 examines each group, step 2556, and for each group G performs the following steps, ultimately creating the Merged Key Sample Groups 1963:
   If the last sample of G has partition keys equal to the partition keys of the last sample of the previous group, append the key samples of G to the previous group and remove G.
   Otherwise if the first sample of G has partition keys equal to the partition keys of the last sample of the previous group, move all samples with matching partition key values from G and append them to the previous group.
The Key Sample to Split Convertor module 1954 creates a Key Range Split 1943 for each Merged Key Sample Group 1963 in step 2558 as follows:
   For the first Merged Key Sample Group 1963, create a Key Range Split 1943, setting the lower bound equal to the lowest possible partition key tuple.
   For each subsequent Merged Key Sample Group 1963, create a Key Range Split 1943, setting the lower bound equal to the first key sample of the Merged Key Sample Group 1963.
   For the last created Key Range Split 1943, set the upper bound equal to the highest possible partition key tuple.
   For any Key Range Split 1943 other than the last, set the upper bound equal to the lower bound of the following Key Range Split 1943.

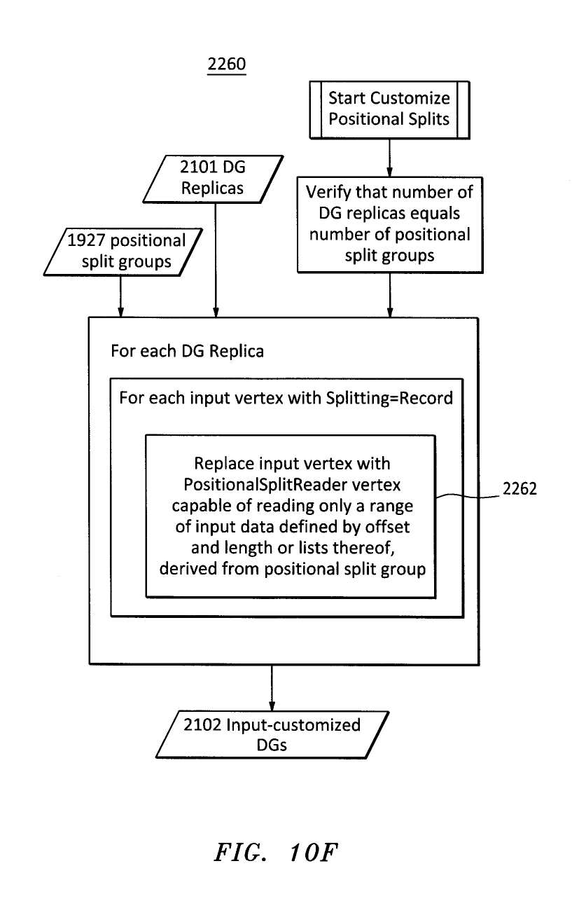

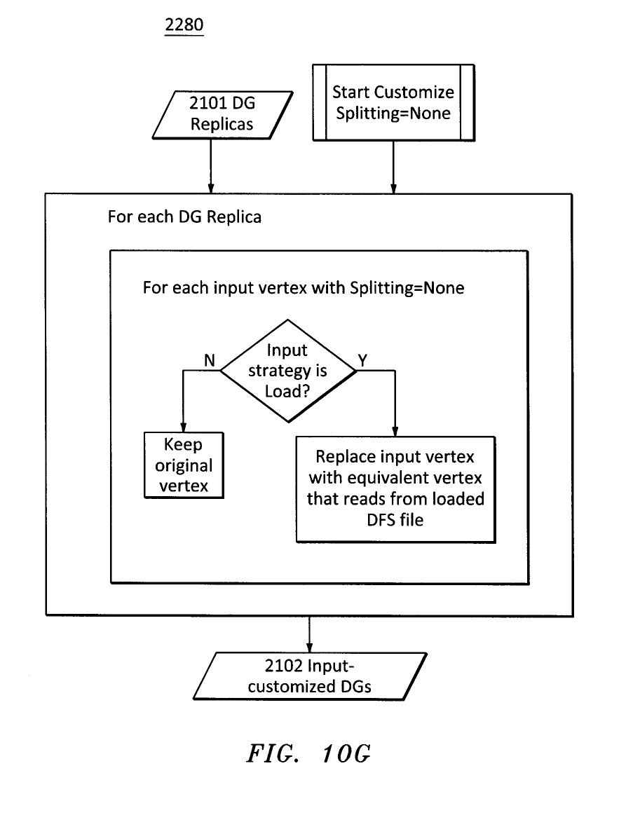

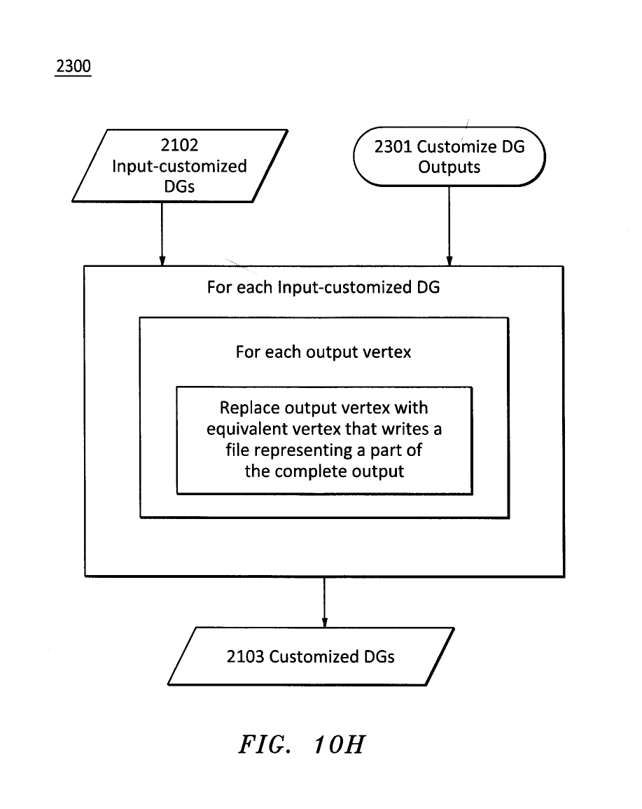

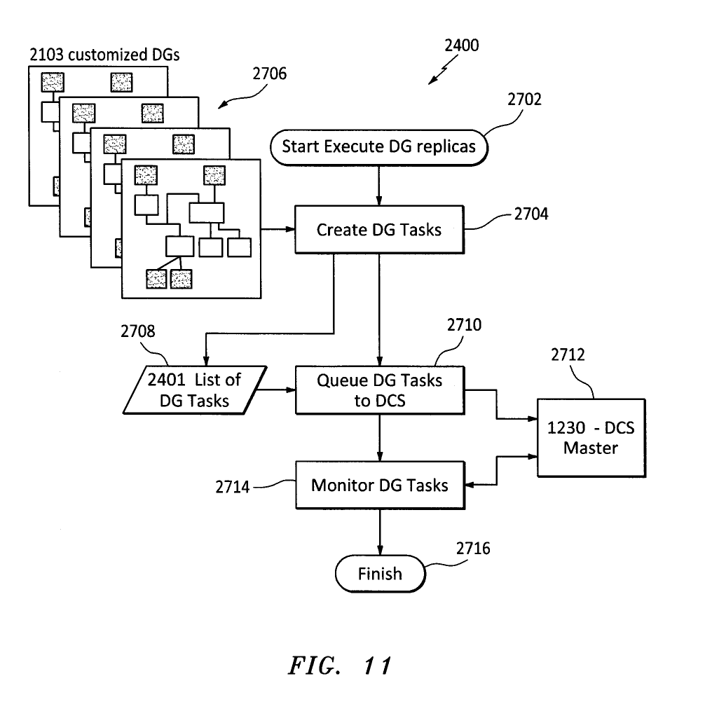

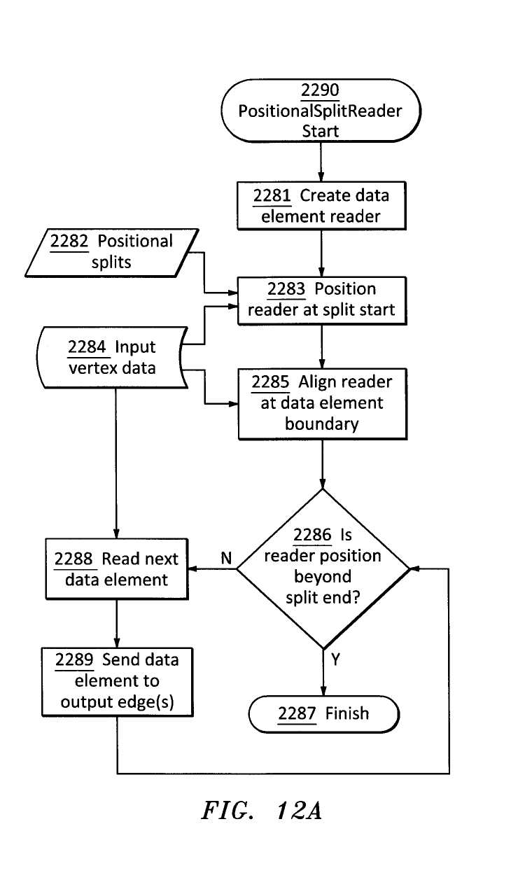

Once the input vertex data has been conditioned, and the positional split groups 1927 or key range splits 1943 have been created, the method invokes the DG Customizer 2000, FIGS. 10A-10B, to replicate and customize the input DG 1601, set 2604. Noting that, in one construction, the preceding technique excludes certain invalid combinations of input vertex attributes 1603, FIG. 6B, and in particular guarantees that at most one set of positional split groups 1927 or key range splits 1943 have been created, set 2606, FIG. 10B, the DG Customizer 2000, illustrated schematically within dashed line 2602 in FIG. 10B, follows these steps:
After start 2600, the DG Replicator 2100, module 2608, creates DG Replicas 2101, set 2610, of the Input DG 1601, set 2604, the number of replicas being equal to the number of positional split groups 1927 or key range splits 1943, set 2606.
For each DG Replica 2101, the DG Input Customizer 2200, module 2612, replaces each input vertex with a customized, novel input vertex, the details of which depend on the results of input strategy analysis 1700, module 2614, and input strategy execution 1800, module 2616, and input split analysis 1900, module 2618, producing input-customized DGs 2102, set 2620.
For each Input-customized DG 2102, the DG Output Customizer 2300, module 2622, replaces each output vertex with a customized, novel output vertex capable of writing an output file fragment, that is, at least a portion of the resulting data instead of a complete output file, to produce customized DGs 2103, set 2624.

The DG Replicator 2100, FIG. 10C, when started, at step or initialization 2630, counts, in module 2634, the number of either positional split groups 1927 or key range splits 1943, set 2632, and creates, in module 2636, one or more DG replicas 2101, set 2640, of the input DG 1601, set 2638, the number of which is equal to that count.

Once the DG replicas 2101 have been created, the DG Input Customizer 2200 is invoked, at step or initialization 2650, FIG. 10D. It follows various strategies to replace input vertices of the input DG 1601 with novel vertices capable of meeting the semantic demands of the input vertex attributes 1603, FIG. 6B, given the results of the input strategy analyzer 1700, input strategy executor 1800, and input split analyzer 1900, FIGS. 6 and 10B.

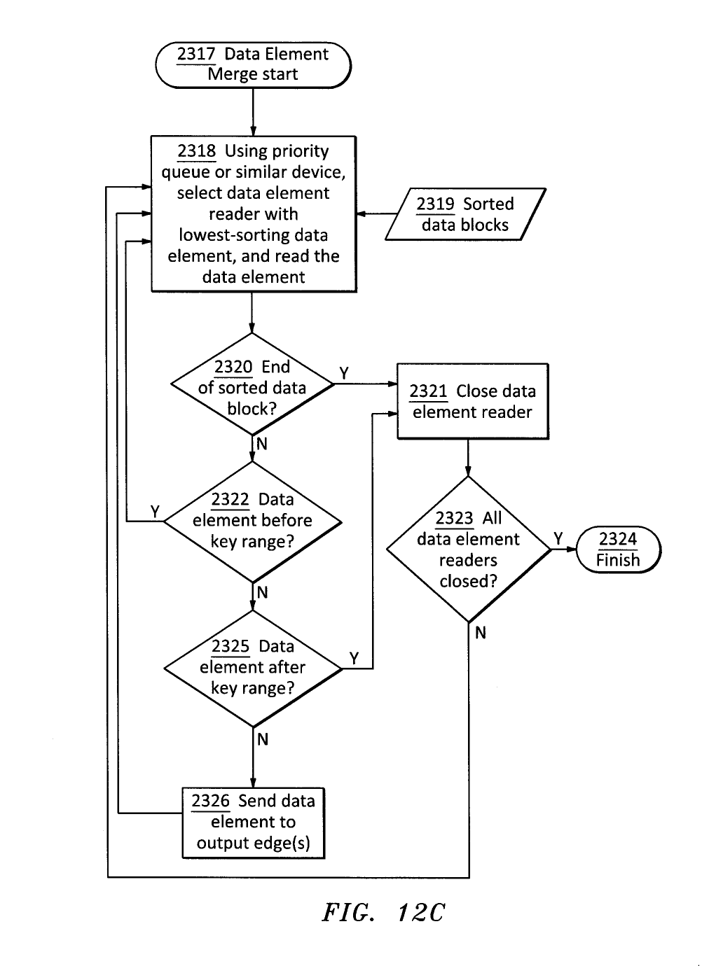

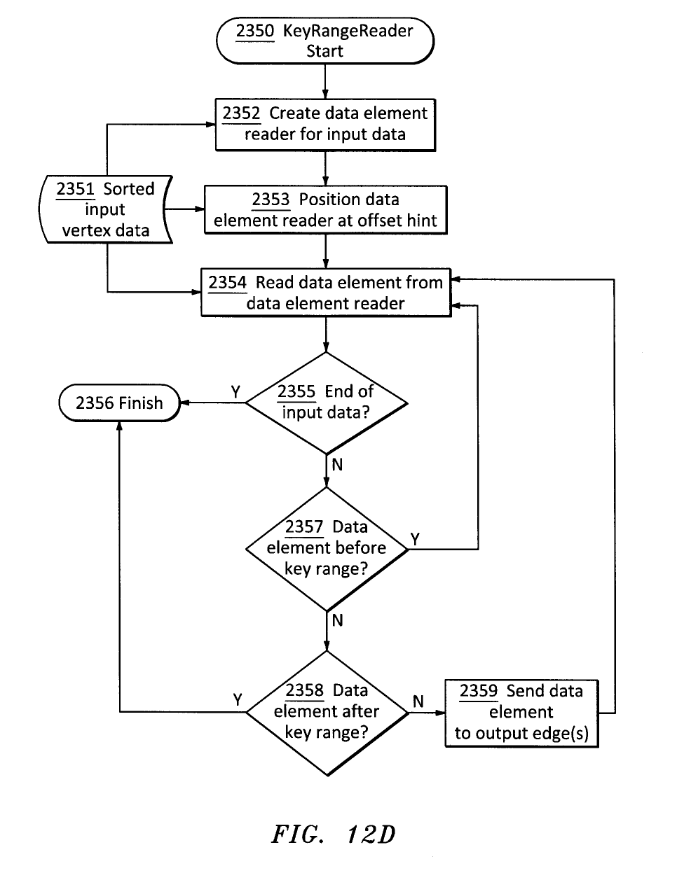

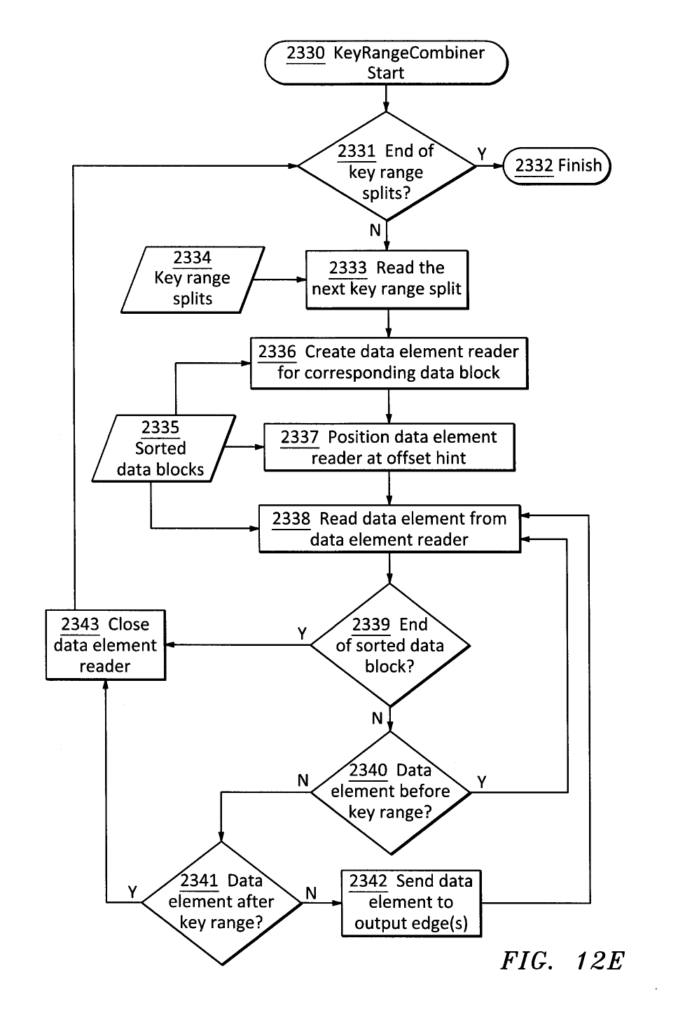

In some constructions, the input customization process assumes the existence of at least one of the following kinds of novel, customized input vertices: PositionalSplitReader, KeyRangeMerger, KeyRangeReader, and KeyRangeCombiner. One possible construction for each of those customized input vertices is described below in relation to FIGS. 12A-12E. One technique according to the present invention finds the input vertex with the largest input data and satisfying Splitting=DataElement or Splitting=Partition, step 2652, FIG. 10D. It is determined in step 2654 whether the largest input has Splitting=DataElement, which as illustrated as “Splitting=DE” in steps 2652 and 2654. If yes, then the technique proceeds to module 2656, Customize Positional Splits 2260, FIG. 10F. In one construction, for the vertex PositionalSplitReader, step 2262, FIG. 10F, reads from a file in any of the supported formats and, for each positional split, starting at the specified offset and reading the specified length, outputs a series of data elements to its output edges in the DG.

If the largest input analyzed at step 2654, FIG. 10D, does not have Splitting=DataElement, then Key Range Splits are customized in module 2658 with Customize Key Range Splits 2230, FIG. 10E. When the vertex is KeyRangeMerger, step 2234 reads from a list of already-sorted files, starting at an offset hint in each file, and reading only data elements whose partition keys fall within a Key Range Split. It uses a priority queue or similar technique to merge data elements simultaneously from all sources, outputting a series of ordered data elements to its output edges in the DG. It ignores all data elements sorting before the Key Range Split. It stops reading each file when that file reaches the end or upon reading a data element sorting after the Key Range Split.

For the vertex KeyRangeReader, step 2232 reads from an already-sorted file or series of files, starting at a suggested offset in the file(s), and reading only data elements whose partition keys fall within the specified Key Range Split. It reads data elements sequentially from the file, ignoring all data elements sorting before the Key Range Split and stopping when it reaches the end of file or upon reading a data element sorting after the Key Range Split. It outputs all data elements to its output edges in the DG.

For the vertex KeyRangeCombiner, step 2236 reads from a list of already-sorted files, starting at a suggested offset in each file, and reading only data elements whose partition keys fall within a Key Range Split. It may read data elements sequentially or in parallel from all sources, outputting a series of unordered data elements to its output edges in the DG. It ignores all data elements sorting before the Key Range Split. It stops reading each file when that file reaches the end or upon reading a data element sorting after the Key Range Split.

In one construction, the DG Input Customizer 2200 performs its customization as follows: First, it finds the input vertex with the largest input data size (by bytes or data element count, typically). If that input vertex has the input attribute 1603 Splitting=DataElement, it follows a Key Range Split customization procedure 2230, otherwise it follows a Positional Split customization procedure 2260, and in either case finishes the customization process by customizing those vertices with input attribute 1603 Splitting=None 2280.

In one construction, the Key Range Split customization procedure 2230 is described as performing, for each DG replica R 2101:
For each input vertex V in R with input attribute 1603 Splitting=Partition

If the input strategy assigned to V is LoadSample

Replace V with a KeyRangeReader vertex capable of reading the given Key Range Split

Otherwise, If the input strategy assigned to V is LoadSort or DistributedSort

Replace input vertex with a KeyRangeMerger vertex capable of reading the given Key Range Split over the collection of sorted data files

Otherwise If the input strategy assigned to V is DistributedPartition

Replace input vertex with a KeyRangeCombiner vertex capable of reading the given Key Range Split over the collection of sorted data files

Store the resulting customized DG replicas to Input-customized DGs 2102

In one construction, the Positional Split customization procedure 2260 is described as performing, for each DG replica R 2101:

For each input vertex V in R with input attribute 1603 Splitting=DataElement

Replace input vertex with PositionalSplitReader vertex capable of reading only a range of input data defined by offset and length or lists thereof, derived from positional split group

Store the resulting customized DG replicas to Input-customized DGs 2102

In one construction, the Splitting=None customization procedure 2280 is described as performing, for each DG replica R 2101:

For each input vertex V in R with input attribute 1603 Splitting=None

If the input strategy assigned to V is Load

Replace the input vertex with an input vertex that is equal in all respects to the original except that it reads from the DFS to which the input data was loaded

Otherwise, keep the original the input vertex

Store the resulting customized DG replicas to Input-customized DGs 2102. In summary for one construction, each of procedures 2230, 2260 and 2280 are peer processes that all conduct transformation of each DG replica 2101 to an input-customized DG 2102.

In one construction, the DG Input Customizer 2300, FIG. 1011, performs its customization as follows for each Input-customized DG replica R 2102:

For each output vertex V in R

Replace the output vertex with an output vertex that is equal in all respects to the original except that it writes to a “file part” instead of the original file. This step typically is done when the FS is a DFS because most DFS do not support simultaneous writing of sections of the same file when the size of those sections is not known beforehand.

Store the resulting customized DG replicas to Customized. DGs 2103. This customization results in the collection of DG tasks producing a set of output files, one for each Output vertex, instead of a single output file. For the construction illustrated in FIG. 1011, each Input-customized DG Replica 2012 has each Output vertex replaced, to generate Customized DGs 2103.

The DG Replica Executor 2400, FIG. 11, also referred to as the DG executor 2400, interfaces with the DCS Master 1230, module 2712, in one construction utilizing a DCS. When initialized at step 2702, the DG executor 2400 creates in module 2704 a task, in set 2708, for each customized DG 2103, in set 2706. In this construction, the DG executor requests worker affinity for tasks in module 2710 including queue DG tasks to the DCS. Execution of said tasks is monitored via module 2714 and, when all tasks have completed successfully, step 2716, the completion is reported to the user. Variations on DCS implementation may dictate different specific implementations of DG replica execution without affecting the generality of the invention.

In one construction, customized input vertices to be implemented include PositionalSplitReader 2290, FIG. 12A, KeyRangeMerger 2310, FIGS. 12B-12C, KeyRangeReader 2350, FIG. 12D, and KeyRangeCombiner 2330, FIG. 12E.

For PositionalSplitReader 2290, FIG. 12A, a data element reader is created, step 2281, and the reader is positioned at the start of each split, step 2283, as obtained from set 2282 of Positional splits. Input vertex data 2284 is also considered at step 2283, as well as at steps 2285 and 2288. The reader is aligned at a data element boundary, step 2285, and the position of the reader is analyzed at query step 2286. If the reader is not positioned beyond split end, then the technique reads the next data element at step 2288. That data element is then sent to at least one output edge, step 2289, and the technique returns to step 2286 in a loop that continues until the reader is positioned beyond split end, terminating in finish, step 2287.

For KeyRangeMerger 2310, FIG. 12B, the technique first loops over all key range splits in this construction. If the end of key range splits has not been reached, query step 2313, then the next key range split is read, step 2314, and a data element reader is created for the corresponding data block, step 2315. Key range splits 2313 are considered at step 2314 and sorted data blocks 2311 are considered at step 2315. The data element reader is then positioned at offset hint, step 2316, and the technique loops to query step 2313 until the end of key range splits is reached, at which time a step 2317 for Data Element Merge is started in FIG. 12C.

Using priority queue or similar device to review sorted data blocks 2319, FIG. 12C, the data element reader with lowest-sorting data element is selected, step 2318, and that data element is read. If the end of the selected sorted data block has not been reached at query step 2320, it is determined whether data element is before key range, query step 2322. If not, it is determined whether data element is after key range, query step 2325. An affirmative answer to either of query steps 2320 or 2325 causes the technique to close the data element reader at step 2321; an affirmative answer to query step 2322 causes the technique to loop back to step 2318. A negative answer to query step 2325 causes the data element to be sent to at least one output edge, step 2326, before the technique returns to step 2318. After step 2321 has been reached and the data element reader has been closed, it is determined whether all data element readers have been closed, query step 2322. If not, then the technique loops to step 2318; if all data element readers have been closed, then the process finishes, step 2324.

For KeyRangeReader 2350, FIG. 12D, the technique begins by creating a data element reader, step 2352, for input data from sorted input vertex data 2351, which also supplies step 2353 to position the data element reader at offset hint and step 2354 to read a data element from the data element reader, respectively. If it is determined at query step 2355 that the end of input data has not been reached, it is then determined at query step 2357 whether the data element is before key range. If yes, then the technique loops back to step 2354; if no, then it is determined in query step 2358 whether the data element is after key range. If no, then the data element is sent to at least one output edge, step 2359, before the technique returns to step 2354. When either step 2355 or step 2358 is satisfied, then the technique finishes, step 2356.

For KeyRangeCombiner 2330, FIG. 12E, the technique begins by determining if the end of key range splits has been reached, query step 2331. If not, then the next key range split is read, step 2333, from key range splits 2334. A data element reader is then created for the corresponding data block, as supplied by sorted data blocks 2335. The data element reader is positioned at offset hint, step 2337, and the data element is read from the data element reader, step 2338. Both of steps 2337 and 2338 also access sorted data blocks 2335. It is then determined at query step 2339 whether the end of sorted data block has been reached. If the end has not been reached, then query step 2340 determines whether the data element is before key range. If before, then the technique returns to step 2338; if not, then it is determined at query step 2341 whether the data element is after key range. If not after, then the data element is sent to one or more output edges, step 2342, before the technique loops to step 2338. If the query at either of steps 2339 or 2341 is satisfied, then the data element reader is closed, step 2343, and the technique returns to step 2331. Once the end of key range splits has been reached, the technique finishes, step 2332.

As a generalization regarding input from databases, the description of this method focuses on DGs with Input vertices whose data is stored in files, especially files stored in the DFS. However, ETL software is capable of reading from non-file sources, such as databases. The method can be generalized to include input from databases that have the following attributes:
The storage of the database is arranged in such a manner that the data is divided into “Segments” (a.k.a. Partitions or Regions), and each Segment or copy thereof may reside on a different Node.
The database provides an interface for querying which Segments reside on which Nodes.
The database provides an interface for restricting query results to specific Segments.
   The described method generalizes to databases that possess these attributes, by making the following changes to the above description:
Instead of Inputs reading from DFS files, consider Inputs reading from database queries.
Instead of “file blocks”, use “database Segments”.
Instead of Positional splits, use “queries restricted to database Segments”.

Although specific features of the present invention are shown in some drawings and not in others, this is for convenience only, as each feature may be combined with any or all of the other features in accordance with the invention. While there have been shown, described, and pointed out fundamental novel features of the invention as applied to one or more preferred embodiments thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is the intention, therefore, to be limited only as indicated by the scope of the claims appended hereto. Other embodiments will occur to those skilled in the art and are within the following claims.

What is claimed is:

1. A method for performing data-processing in a computing environment including a file system (FS) and a computing system (CS) to process at least one original Directed Graph (DG) having multiple edges and vertices, the DG including at least one input vertex representing a source of data elements from the FS with each input vertex having at least one attribute that specifies data element processing constraints, at least one output vertex representing a destination of data elements, and at least one transform vertex representing at least one transformation operation on the data elements, the method comprising:
receiving the at least one DG to analyze and condition data elements available from the at least one input vertex and selecting a conditioning strategy;
customizing the original DG into at least one customized DG including, for each DG to be customized: (i) replacing each input vertex with a customized input vertex that reads at least a portion of at least one of (1) original input data and (2) data that results from the selected conditioning strategy; and (ii) replacing each output vertex with a customized output vertex that writes at least a portion of the data;
creating a list of tasks for execution in the CS wherein each task processes at least a portion of at least one customized DG; and
delivering the tasks to the CS for processing in an execution engine capable of performing requested data transformations in the computing environment.

2. The method of claim 1 wherein a distributed computing system (DCS) is selected as the CS, the DCS including at least one processor and at least one memory storage unit.

3. The method of claim 2 wherein a distributed file system (DFS) is selected as the FS, and the DFS and the DCS are interconnected with each other.

4. The method of claim 3 wherein creating the list of tasks includes constructing tasks that run on the DCS to analyze and condition at least a portion of the data elements.

5. The method of claim 1 further including selecting the execution engine to be capable of accurately executing semantics defined by each customized DG.

6. The method of claim 1 further including selecting the computing environment to be a parallel computing environment including processing that is distributed among a plurality of nodes.

7. The method of claim 1 further including assigning worker affinity to the tasks.

8. The method of claim 3 wherein selecting a conditioning strategy includes constraining at least some of the input vertices of the DG by at least one parameter specified by a user.

9. The method of claim 8 wherein constraining includes a splitting constraint which limits how data elements from each input are divided.

10. The method of claim 9 wherein each division is mapped onto a task.

11. The method of claim 8 wherein constraining includes requiring data elements containing the same key values to be assigned to the same task.

12. The method of claim 8 further including specifying a list of at least one of partition key fields and a partition type.

13. The method of claim 12 wherein the key fields and other data are produced by an arbitrary transformation, specified in terms of a sub-DG, and the input data.

14. The method of claim 8 wherein each input is analyzed to determine which strategy must be followed to condition the input data for processing in order to meet the user-specified input constraint.

15. The method of claim 14 wherein the conditioning strategy for an input is chosen based upon at least one of: a user constraint; user partition key fields; user partition type; whether the data already resides in the DFS; and whether the data is already sorted on the partition keys.

16. A system for performing data-processing in a computing environment, comprising:
a file system (FS);
a computing system (CS) including at least one processor and at least one memory storage unit, to process at least one original Directed Graph (DG) having multiple edges and vertices, the DG including at least one input vertex representing a source of data elements from the FS with each input vertex having at least one attribute that specifies data element processing constraints, at least one output vertex representing a destination of data elements, and at least one transform vertex representing at least one transformation operation on the data elements;
an analysis and conditioning module to receive the at least one DG to analyze and condition data elements available from the at least one input vertex and to enable a user to select a conditioning strategy;
a customizer module to customize the original DG into at least one customized DG including, for each DG to be customized: (i) replacing each input vertex with a customized input vertex that reads at least a portion of at least one of (1) original input data and (2) data that results from the selected conditioning strategy; and (ii) replacing each output vertex with a customized output vertex that writes at least a portion of the data; and
an executor module to create a list of tasks for execution in the CS wherein each task processes at least a portion of at least one customized DG, and to deliver the tasks to the CS for processing in an execution engine capable of performing requested data transformations in the computing environment.

17. The system of claim 16 wherein the FS is a distributed file system (DFS), the CS is a distributed computing system (DCS), the DFS includes at least one interconnected storage medium, and wherein the DFS and the DCS are interconnected with each other.

18. The system of claim 17 wherein the executor module to create the list of tasks includes constructing tasks that run on the DCS to analyze and condition at least a portion of the data elements.

19. The system of claim 16 further including the execution engine, the execution engine being capable of accurately executing semantics defined by each customized DG.

20. The system of claim 16 wherein the computing environment is a parallel computing environment including a plurality of nodes, and processing is distributed among the nodes.
